(19) United States
(12) Patent Application Publication
(10) Pub. No.: US 2006/0291217 A1
(43) Pub. Date: Dec. 28, 2006

(54) Lighted inflated or inflatable objects

(76) Inventor: Carl R. Vanderschuit, San Diego, CA (US)

Correspondence Address: HARNESS, DICKEY, & PIERCE, P.L.C, 7700 BONHOMME, STE 400, ST. LOUIS, MO, 63105, US

(21) Appl. No.: 11/486,718

(22) Filed: Jul. 14, 2006

Related U.S. Application Data
(63) Continuation-in-part of application No. 10/797,251, filed on Mar. 10, 2004, now Pat. No. 7,077,553.
(63) Continuation-in-part of application No. 11/483,442, filed on Jul. 10, 2006.
Application No. 11/483,442 is a continuation-in-part of application No. 10/851,510, filed on May 21, 2004, now Pat. No. 7,073,917.
Application No. 11/483,442 is a continuation-in-part of application No. 10/961,364, filed on Oct. 8, 2004.
Application No. 11/483,442 is a continuation-in-part of application No. 11/442,625, filed on May 26, 2006.
Application No. 11/442,625 is a continuation-in-part of application No. 10/606,314, filed on Jun. 25, 2003, now Pat. No. 7,052,154.
(60) Provisional application No. 60/454,179, filed on Mar. 11, 2003.
(60) Provisional application No. 60/719,011, filed on Sep. 21, 2005.
(60) Provisional application No. 60/510,778, filed on Oct. 10, 2003.

(51) Int. Cl. F21S 13/10

(52) U.S. Cl. 362/363

(57) ABSTRACT

According to various aspects of the present disclosure, an inflated or inflatable object generally includes at least one light source for illuminating at least a portion of the inflated or inflatable object. The inflated or inflatable object may be a balloon, a ball, a lamp, a furniture piece, a raft, a pillow, a slide, a bouncing platform (e.g., bounce house, etc.), a swimming pool, a support for a body part, etc. In various embodiments, at least a portion of an inflated or inflatable object's skin is black-light sensitive, and at least one light source emits black light so as to illuminate the black-light sensitive portion of the skin. Other aspects of the present disclosure relate generally to methods relating to using, assembling, disassembling, and/or making lighted inflated or inflatable objects. Further aspects of the present disclosure relate to kits including components capable of being assembled into a lighted inflated or inflatable object. Additional aspects relate to methods that generally include receiving such a kit, and assembling the components within the kit into a lighted inflated or inflatable object.

### CROSS-REFERENCE TO RELATED APPLICATIONS

This application is a continuation-in-part of presently allowed U.S. patent application Ser. No. 10/797,251 filed Mar. 10, 2004, which, in turn, claimed the benefit of U.S. Provisional Patent Application No. 60/454,179 filed Mar. 11, 2003.

This application claims the benefit of U.S. Provisional Patent Application No. 60/719,011 filed Sep. 21, 2005.

This application is a continuation-in-part of U.S. patent application Ser. No. 11/483,442 filed Jul. 10, 2006, which, in turn, is:
a continuation-in-part of U.S. patent application Ser. No. 10/851,510 filed May 21, 2004 (now U.S. Pat. No. 7,073,917, issued Jul. 11, 2006); and
a continuation-in-part of U.S. patent application Ser. No. 10/961,364 filed Oct. 8, 2004, which, in turn, claimed priority to U.S. Provisional Application 60/510,778 filed Oct. 10, 2003; and
a continuation-in-part of U.S. patent application Ser. No. 11/442,625 filed May 26, 2006, which, in turn, is a continuation-in-part of U.S. patent application Ser. No. 10/606,314 filed Jun. 25, 2003 (now U.S. Pat. No. 7,052,154, issued May 30, 2006).

The disclosures of the above applications are incorporated herein by reference.

### FIELD

The present disclosure relates generally to lighted inflated or inflatable objects.

### BACKGROUND

The statements in this background section merely provide background information related to the present disclosure and may not constitute prior art.

Many people tend to associate inflated objects (e.g., such as balloons, beach balls and swimming pool rafts, etc.) with recreation, fun and festivity. Balloons are beloved as both toys and as decorations by children and adults. Inflatable furniture is also fun, inexpensive, and particularly popular among children, adolescents, and young adults. Such items tend to be colorful, lightweight, and attractive to the eye.

### SUMMARY

According to various aspects of the present disclosure, an inflated or inflatable object generally includes at least one light source for illuminating at least a portion of the inflated or inflatable object. The inflated or inflatable object may be a balloon, a ball, a lamp, a furniture piece, a raft, a pillow, a slide, a bouncing platform (e.g., bounce house, etc.), a swimming pool, a support for a body part, etc. In various embodiments, at least a portion of an inflated or inflatable object's skin is black-light sensitive, and at least one light source emits black light so as to illuminate the black-light sensitive portion of the skin. Other aspects of the present disclosure relate generally to methods relating to using, assembling, disassembling, and/or making lighted inflated or inflatable objects. Further aspects of the present disclosure relate to kits including components capable of being assembled into a lighted inflated or inflatable object. Additional aspects relate to methods that generally include receiving such a kit, and assembling the components within the kit into a lighted inflated or inflatable object.

In one exemplary embodiment, an apparatus generally includes an inflated or inflatable object having at least one portion responsive to black light. At least one source is disposed within the inflated or inflatable object. The at least one light source includes at least one black light source for directing black light generally towards the at least one black light-responsive portion.

In another exemplary embodiment, an apparatus generally includes an inflated or inflatable object having a closable inflation neck through which the inflatable object can be inflated. At least one light source is within the inflated or inflatable object. Wiring connects the at least one power source to the at least one light source. At least one switching device is configured such that the squeezing the inflation neck activates the switching device, and, thereby, to switchably connect the at least one light source to the at least one power source.

In another exemplary embodiment, an apparatus generally includes an inflated or inflatable object having an inflation opening, at least one seam extending at least partially along at least a portion of the inflated or inflatable, and at least one casing formed at the at least one seam. At least one light source is within the casing.

In another exemplary embodiment, an apparatus generally includes an inflated or inflatable object having at least one inflation opening, at least one light source within the inflated or inflatable object, and at least one tube through which wiring extends for connecting the at least one light source to at least one power source. The at least one tube is substantially entirely enclosed within the inflated or inflatable object. At least one light-altering member is configured for receiving and altering light from the at least one light source by at least one or more of refracting, reflecting, diffracting, dispersing, and diffusing such that the altered light illuminates at least a portion of the inflated or inflatable object.

Other exemplary embodiments include lighting devices, which can be used in connection with inflated or inflatable objects having at least one inflation opening through which the inflated or inflatable object can receive fluid therein. In one exemplary embodiment, a lighting device generally includes at least one light source and at least one tube through which wiring extends for connecting the at least one light source to at least one power source. The lighting device can also include at least one light-altering member at least partially supported by the tube and insertable through the at least one inflation opening for positioning within the inflated or inflatable object. The light-altering device can receive and alter light from the at least one light source by at least one or more of refracting, reflecting, diffracting, dispersing, and diffusing such that the altered light illuminates at least a portion of the inflated or inflatable object.

In another exemplary embodiment, a lighting device generally includes a first tube having at least one inner fluid flow passage therethrough in which fluid may be received and delivered through the at least one inner fluid flow passage into the inflatable or inflated object. The lighting device also includes a second tube having at least one inner cavity therein. At least a portion of the second tube is situated in the at least one inner fluid flow passage such that fluid may be received in and drawn through the at least one inner fluid flow passage generally around and past the at least a portion of the second tube in the at least one inner fluid flow passage. At least one light source is at least partially positioned within the at least one inner cavity of the second tube. At least one housing is configured to receive at least one power source therein for electrically powering the at least one light source. At least a portion of the at least one housing is situated in the at least one inner fluid flow passage such that fluid may be received in and drawn through the at least one inner fluid flow passage generally around and past the at least a portion of the at least one housing in the at least one inner fluid flow passage. At least one electrically-conductive lead extends from the at least one light source through at least a portion of the at least one inner cavity of the second tube to the at least one housing for electrically connecting the at least one light source to the at least one power source within the at least one housing.

Further aspects and features of the present disclosure will become apparent from the detailed description provided hereinafter. In addition, any one or more aspects of the present disclosure may be implemented individually or in any combination with any one or more of the other aspects of the present disclosure. It should be understood that the detailed description and specific examples, while indicating exemplary embodiments of the present disclosure, are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of another exemplary embodiment of a lighted balloon apparatus;

FIG. 2 is a perspective view of another exemplary embodiment of a lighted balloon apparatus;

FIG. 3 is a perspective view of another exemplary embodiment of a lighted balloon apparatus;

FIG. 4A is a perspective view of another exemplary embodiment of a lighted balloon apparatus;

FIG. 4B is a cross-sectional partial view of the balloon apparatus shown in FIG. 4A;

FIG. 5 is a perspective view of another exemplary embodiment of a lighted balloon apparatus;

FIG. 6 is a perspective view of another exemplary embodiment of a lighted balloon apparatus;

FIG. 7 is a perspective view of another exemplary embodiment of a lighted balloon apparatus;

FIG. 8 is a perspective view of another exemplary embodiment of a lighted balloon apparatus;

FIG. 9 is a perspective view of another exemplary embodiment of a lighted balloon apparatus;

FIG. 10 is a perspective view of another exemplary embodiment of a lighted balloon apparatus;

FIG. 11 is a perspective view of another exemplary embodiment of a lighted balloon apparatus;

FIG. 12 is a perspective view of an exemplary embodiment of an inflated or inflatable lighted object;

FIG. 13 is a perspective view of an exemplary embodiment of an inflated or inflatable lighted ball;

FIG. 14 is a perspective view of an exemplary embodiment of an inflated or inflatable lighted lamp;

FIG. 15 is a perspective view of an exemplary embodiment of an inflated or inflatable lighted chair;

FIG. 16 is a perspective view of an exemplary embodiment of an inflated or inflatable lighted sofa;

FIG. 17 is a perspective view of an exemplary embodiment of an inflated or inflatable lighted pillow;

FIG. 18 is a perspective view of an exemplary embodiment of an inflated or inflatable lighted raft;

FIG. 19 is a perspective view of another exemplary embodiment of a lighted balloon apparatus;

FIG. 20 is an exploded perspective view of an exemplary lighting apparatus that can used in connection with an inflated or inflatable object in accordance with exemplary embodiments;

FIG. 21 is an end perspective view of the lighting apparatus shown in FIG. 20 after the components have been assembled; and

FIG. 22 is an exploded perspective view of another exemplary lighting apparatus that can be in connection with an inflated or inflatable object in accordance with exemplary embodiments.

### DETAILED DESCRIPTION

The following description is merely exemplary in nature and is in no way intended to limit the present disclosure, application, or uses.

According to various aspects of the present disclosure, an inflated or inflatable object generally includes at least one light source for illuminating at least a portion of the inflated or inflatable object. The inflated or inflatable object may be a balloon, a ball, a lamp, a furniture piece, a raft, a pillow, a slide, a bouncing platform (e.g., bounce house, etc.), a swimming pool, a support for a body part, etc. In various embodiments, at least a portion of an inflated or inflatable object's skin is black-light sensitive, and at least one light source emits black light so as to illuminate the black-light sensitive portion of the skin. Other aspects of the present disclosure relate generally to methods relating to using, assembling, disassembling, and/or making lighted inflated or inflatable objects. Further aspects of the present disclosure relate to kits including components capable of being assembled into a lighted inflated or inflatable object. Additional aspects relate to methods that generally include receiving such a kit, and assembling the components within the kit into a lighted inflated or inflatable object.

In various embodiments, a balloon apparatus includes a balloon having an inflation opening that can be closed for keeping the balloon inflated. The apparatus also includes a light source inside the balloon, wiring connecting a power source to the light source, and a tube through which the wiring extends. The tube can be entirely enclosed in the balloon.

In other embodiments, a balloon apparatus includes a balloon having an inflation opening that can be closed for keeping the balloon inflated. The apparatus also includes a light source inside the balloon, wiring connecting a power source to the light source, and a tube through which the wiring extends. The tube at least partially supports at least one member configured for display within the balloon.

In further embodiments, a balloon apparatus includes a balloon having an inflation neck, a closure member configured to close the neck to keep the balloon inflated, a light source inside the balloon, wiring connecting a power source outside the balloon to the light source, and a device extending through the closed neck and supporting at least a portion of the wiring. The device can be moved by a user to thereby move the light source in the balloon.

In additional embodiments, a kit for making a balloon apparatus includes a light source inserted or insertable within a balloon having an opening through which the balloon is inflatable. The kit also includes a power source connected or connectable to the light source via conductive wiring, and a tube through which the wiring is extended or extendable. The tube is configured to fit inside the balloon and support the light source when the balloon is inflated and the opening is sealed.

In still other embodiments, a kit for making a balloon apparatus includes a light source inserted or insertable into a balloon. The balloon has a neck through which the balloon is inflatable. The neck is sealable to keep the balloon inflated. The kit also includes a gas-tight tube through which the wiring extends or is extendable. The tube has one end inserted or insertable into the balloon and configured to support the light source. The tube is further configured to extend outside the balloon when the balloon is inflated and the neck is sealed. Also included in the kit are a clip for sealing the neck, and a sleeve configured to over the tube and to support the clip to prevent or inhibit deflation of the balloon when the clip is applied to the neck. The sleeve can be further configured to permit movement of the tube by a user to move the light source within the inflated balloon.

In some embodiments, a method of constructing a balloon apparatus includes extending wiring through a tube, electrically connecting the wiring between a light source and a power source, and inserting the light source and at least one end of the tube into a balloon through a neck through which the balloon is inflatable. In other embodiments, a balloon apparatus includes a balloon having an inflation opening and an electroluminescent light source applied to an outer portion of the balloon.

In one exemplary embodiment, an apparatus generally includes an inflated or inflatable object having at least one portion responsive to black light. At least one source is disposed within the inflated or inflatable object. The at least one light source includes at least one black light source for directing black light generally towards the at least one black light-responsive portion.

In another exemplary embodiment, an apparatus generally includes an inflated or inflatable object having a closable inflation neck through which the inflatable object can be inflated. At least one light source is within the inflated or inflatable object. Wiring connects the at least one power source to the at least one light source. At least one switching device is configured such that the squeezing the inflation neck activates the switching device, and, thereby, to switchably connect the at least one light source to the at least one power source.

In another exemplary embodiment, an apparatus generally includes an inflated or inflatable object having an inflation opening, at least one seam extending at least partially along at least a portion of the inflated or inflatable, and at least one casing formed at the at least one seam. At least one light source is within the casing.

In another exemplary embodiment, an apparatus generally includes an inflated or inflatable object having at least one inflation opening, at least one light source within the inflated or inflatable object, and at least one tube through which wiring extends for connecting the at least one light source to at least one power source. The at least one tube is substantially entirely enclosed within the inflated or inflatable object. At least one light-altering member is configured for receiving and altering light from the at least one light source by at least one or more of refracting, reflecting, diffracting, dispersing, and diffusing such that the altered light illuminates at least a portion of the inflated or inflatable object.

Other exemplary embodiments include lighting devices, which can be used in connection with inflated or inflatable objects having at least one inflation opening through which the inflated or inflatable object can receive fluid therein. In one exemplary embodiment, a lighting device generally includes at least one light source and at least one tube through which wiring extends for connecting the at least one light source to at least one power source. The lighting device can also include at least one light-altering member at least partially supported by the tube and insertable through the at least one inflation opening for positioning within the inflated or inflatable object. The light-altering device can receive and alter light from the at least one light source by at least one or more of refracting, reflecting, diffracting, dispersing, and diffusing such that the altered light illuminates at least a portion of the inflated or inflatable object.

In another exemplary embodiment, a lighting device generally includes a first tube having at least one inner fluid flow passage therethrough in which fluid may be received and delivered through the at least one inner fluid flow passage into the inflatable or inflated object. The lighting device also includes a second tube having at least one inner cavity therein. At least a portion of the second tube is situated in the at least one inner fluid flow passage such that fluid may be received in and drawn through the at least one inner fluid flow passage generally around and past the at least a portion of the second tube in the at least one inner fluid flow passage. At least one light source is at least partially positioned within the at least one inner cavity of the second tube. At least one housing is configured to receive at least one power source therein for electrically powering the at least one light source. At least a portion of the at least one housing is situated in the at least one inner fluid flow passage such that fluid may be received in and drawn through the at least one inner fluid flow passage generally around and past the at least a portion of the at least one housing in the at least one inner fluid flow passage. At least one electrically-conductive lead extends from the at least one light source through at least a portion of the at least one inner cavity of the second tube to the at least one housing for electrically connecting the at least one light source to the at least one power source within the at least one housing.

Various embodiments shown in FIGS. 1 through 11 and 19 will now be described in connection with transparent, latex-based balloons although aspects of the present disclosure are not so limited. Embodiments are contemplated in which many balloon types, shapes, sizes, colors, and degrees of transparency can be suitable. Such balloons include, but are not limited to, translucent, partly opaque balloons, and balloons of Mylar® and other materials. In addition, any one of the balloon apparatus shown in FIGS. 1 through 11 and 19 can include one or more black lights and/or a balloon having at least a portion of which is black-light sensitive. Or, for example, a different object (e.g., ball, furniture piece, chair, sofa, lamp, raft, pillow, a bouncing platform (e.g., bounce house, etc.), a slide, a swimming pool, body support and/or supports for body parts, etc.) can take the place of the balloon and be used with any one of the other devices shown in FIGS. 1 through 11 and 19.

FIG. 1 illustrates an exemplary balloon apparatus 10 embodying one or more aspects of the present disclosure. As shown in FIG. 1, the balloon apparatus 10 includes an inflated balloon 14 having an inflation opening 18 that is closed for keeping the balloon 14 inflated. In this particular embodiment, the balloon 14 is a latex-based balloon, and the inflation opening 18 is a neck that is closed, for example, using a plastic clip 22. In other embodiments, the balloon may be fabricated of Mylar® or other material, and may have, for example, a translucent or transparent panel or window through which illumination may be visible. In some embodiments, the balloon can be black-light sensitive. In other embodiments, embodiments, one or more portions of the balloon may be black-light responsive or sensitive. For example, patterns, text, logos, other indicia, etc. may be imprinted on the balloon in black-light sensitive dye.

Whereas other balloons may have an inflation opening different from the opening 18, other closing devices (e.g., resilient gasket or ring, etc.) may be used instead of the clip 22. The clip 22 (or other suitable closing device) is configured to seal the balloon 14 sufficiently to keep the balloon inflated, for example, for as long as one or two days while accommodating electrical wiring extending through the opening 18 as further described below. The clip 22 may be one of several clips commonly available for sealing balloons.

A light source 26 inside the balloon 14 is electrically connected via wiring 30 to a power source 34, for example, a battery enclosed in a casing 38 and operable via an off/on switch 40. The wiring 30 includes a pair of insulated wires 42 encased together in a coating 44 to form a single strand 46. The wiring 30 extends from the light source 26 through the closed neck 18 to the power source 34.

The wiring 30 extends through a hollow tube 48 that is enclosed in the balloon 14. The tube 48 is made, for example, of a lightweight plastic tubing the same as or comparable to that used in fabricating soda straws, although other suitable types of tubing could be used. An end 52 of the tube supports the light source 26, which, in the illustrated embodiment, is fixedly mounted in the end 52. In this particular embodiment, the light source 26 is a light-emitting diode (LED). Alternatively, other suitable light sources can also or instead be used, such as incandescent, ultraviolet, black light, and/or fluorescent light sources. The LED 26 can be black-light emitting, and the balloon 14 may be black-light sensitive or include black-light sensitive portions. Generally, light sources described in connection with various embodiments of the present disclosure may include a black-light emitting light source, and balloons and/or other balloon apparatus components described in connection with various embodiments may be black-light sensitive at least in part. Alternative embodiments include light sources that do not emit black lights in addition to or as an alternative to the black light source. In such embodiments, a balloon can be configured such that the balloon does not include any black-light-sensitive portions.

With continued reference to FIG. 1, an end 56 of the tube rests upon the inner surface 60 of the balloon near or over the closed inflation opening 18. The end 56 can be caused to locate on the inner surface 60 in a variety of ways, depending, for example, on a shape and/or diameter of the balloon 14, a length 58 of the wiring 30 between the end 56 and the inner surface 60, a degree of rigidity of the wiring 30, an angle of incline of the wiring 30 and/or the tube 48 from the opening 18, and/or a length of the tube 48. Thus, the light source 26 can be oriented in a plurality of ways inside the balloon 14 while contact between the light source 26 and the inner surface 60 is avoided or inhibited.

In those embodiments that include a black light source, the black light source can emit black light after the power source has been switched on. Black light can then cause the black-light-sensitive portion(s) of the balloon to glow or illuminate.

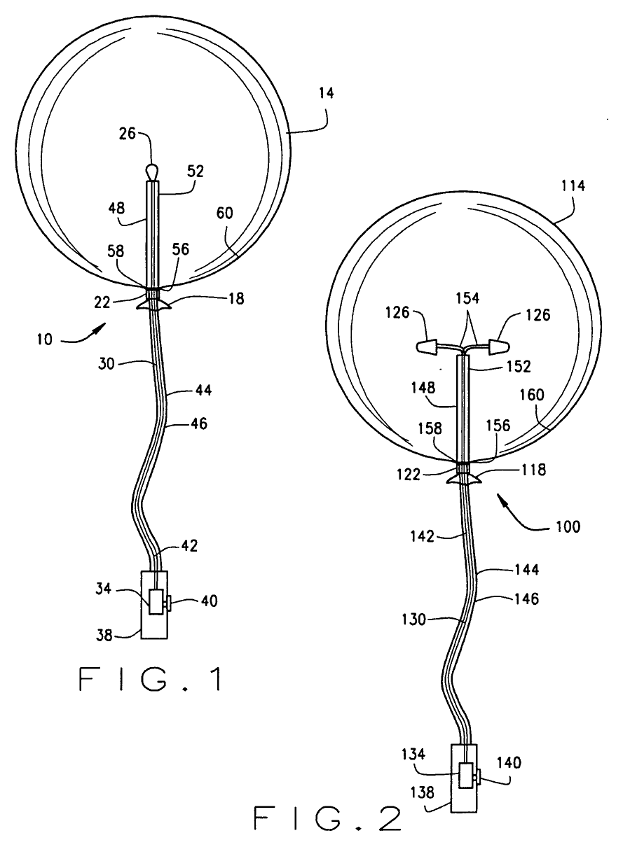

FIG. 2 illustrates another exemplary embodiment of a balloon apparatus 100 embodying one or more aspects of the present disclosure. As shown in FIG. 2, the apparatus 100 includes an inflated balloon 114 having an inflation opening 118 that is closed for keeping the balloon 114 inflated. In this particular embodiment, the balloon 114 is a transparent latex-based balloon, and the inflation opening 118 is a neck that is closed, for example, using a plastic clip 122. The balloon 114 may also be translucent. In other embodiments, the balloon may be fabricated of Mylar® or other material, and may have, for example, a translucent or transparent panel or window through which illumination may be visible. In some embodiments, the balloon can be black-light sensitive. In other embodiments, embodiments, one or more portions of the balloon may be black-light responsive or sensitive. For example, patterns, text, logos, other indicia, etc. may be imprinted on the balloon in black-light sensitive dye.

Other closing devices may be used instead of the clip 122, such as a resilient gasket or ring, etc. The clip 122 (or other suitable closing device) is configured to seal the balloon 114 sufficiently to keep the balloon inflated, for example, for as long as one or two days while accommodating electrical wiring extending through the opening 118 as further described below.

A plurality of light sources 126, for example, two light sources 126, inside the balloon 114 are electrically connected via wiring 130 to a power source 134, for example, a battery enclosed in a casing 138 and operable via an off/on switch 140. In the present embodiment, the light sources 126 are light-emitting diodes (LEDs), although other suitable light sources could be used including black light sources.

The wiring 130 includes a plurality of pairs of insulated wires 142, each pair electrically connecting a corresponding light source 126 with the power source 134. In the embodiment shown in FIG. 2, the pairs of wires 142 are encased together in a coating 144 to form a single strand 146. In other embodiments, the insulated wires 142 may be coated, individually or together, so as to form a plurality of strands. The wiring 130 extends from the light sources 126 through the closed neck 118 to the power source 134.

The wiring 130 extends through a hollow tube 148 that is enclosed in the balloon 114. The tube 148 is made, for example, of a lightweight plastic tubing the same as or comparable to that used in fabricating soda straws, although other suitable types of tubing could be used. The wiring extends through an end 152 of the tube 148, from which the wiring is separated into its component pairs of wires 142. Each light source 126 is thus separated from the tube end 152 by a length 154 of its associated pair of wires 142.

In the embodiment shown in FIG. 2, the light sources 126 are radially arranged relative to the tube end 152. The lengths 154 need not be equal, nor are they required to be straight. A variety of visual effects can be achieved by making the lengths 154 unequal and/or bending the lengths 154, particularly where more than two light sources 126 are provided. Embodiments also are contemplated, wherein a single light source 126 is provided.

An end 156 of the tube rests upon the inner surface 160 of the balloon 114 near or over the closed inflation opening 118. The end 156 can be caused to locate on the inner surface 160 in a variety of ways, depending, for example, on a shape and/or diameter of the balloon 114, a length 158 of the wiring 130 between the end 156 and the inner surface 160, a degree of rigidity of the wiring 130, an angle of incline of the wiring 130 and/or the tube 148 from the opening 118, and/or a length of the tube 148. Thus, the light sources 126 can be oriented in a plurality of ways inside the balloon 114 while contact between the light source and the inner surface 160 can be avoided or inhibited.

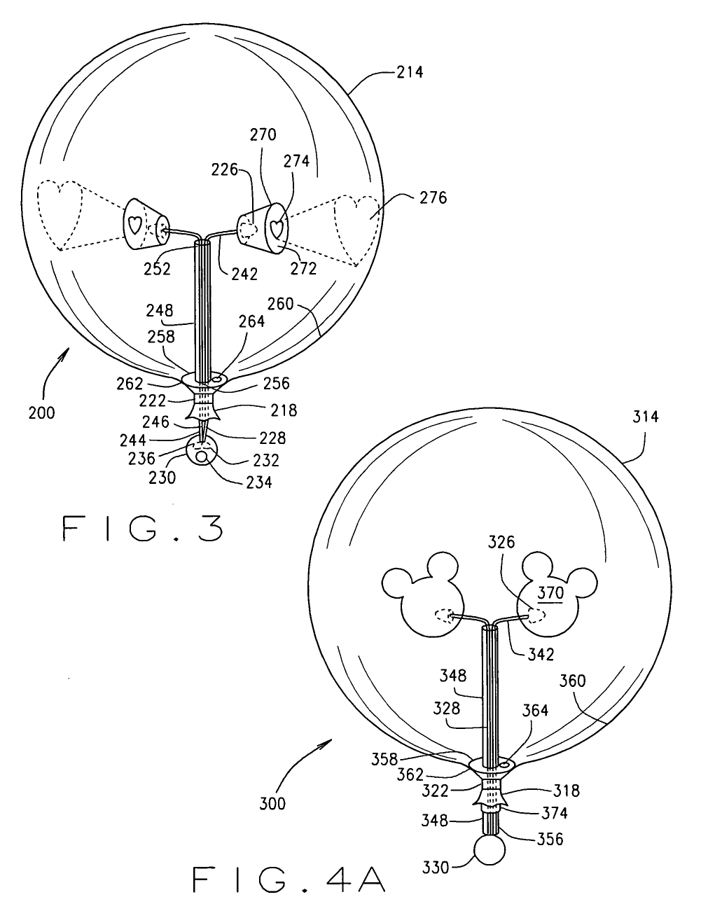

FIG. 3 illustrates another exemplary embodiment of a balloon apparatus 200 embodying one or more aspects of the present disclosure. As shown in FIG. 3, the apparatus 200 includes an inflated balloon 214 having an inflation opening 218 that is closed for keeping the balloon 214 inflated. As shown in FIG. 13, the balloon 214 is a latex-based balloon, and the inflation opening 218 is a neck that is closed, for example, using a plastic clip 222. In other embodiments, the balloon may be fabricated of Mylar® or other material. The balloon 114 may be translucent, transparent, and/or have opaque portions. In other embodiments, the balloon may be fabricated of Mylar® or other material, and may have, for example, a translucent or transparent panel or window through which illumination may be visible. In some embodiments, the balloon can be black-light sensitive. In other embodiments, embodiments, one or more portions of the balloon may be black-light responsive or sensitive. For example, patterns, text, logos, other indicia, etc. may be imprinted on the balloon in black-light sensitive dye.

Other closing devices may be used instead of the clip 222, such as a resilient gasket or ring, etc. The clip 222 (or other suitable closing device) is configured to seal the balloon 214 sufficiently to keep the balloon inflated, for example, for as long as one or two days while accommodating electrical wiring extending through the opening 218 as further described below.

A plurality of light sources 226, for example, two light sources 226, inside the balloon 214 are electrically connected via wiring 228 to a power source, for example, a control chip 230 having a battery 232 operable via a switch 234. The control chip 230 also includes a control circuit 236 for controlling the light sources 226 to provide such features as blinking, strobing, and/or color changes. In the present embodiment, the light sources 226 are light-emitting diodes (LEDs), although other suitable light sources could be used (e.g., black light sources, etc.).

The wiring 228 includes a plurality of pairs of insulated wires 242, each pair electrically connecting a corresponding light source 226 with the power source 230. In the embodiment shown in FIG. 3, the pairs of wires 242 are encased together in a coating 244 to form a single strand 246. In other embodiments, the insulated wires 242 may be coated, individually or together, or selectively left uncoated, so as to form a plurality of strands. The wiring 228 extends from the light sources 226 through the closed neck 218 to the power source 230.

In the present embodiment, the power source 230 is attached proximate or close to (e.g., such as up to about one inch away from, etc.) the neck 218 of the balloon 214. The wiring 228 extends through a hollow tube 248 that is enclosed in the balloon 214. The tube 248 is made, for example, of a lightweight plastic tubing the same as or comparable to that used in fabricating soda straws, although other suitable types of tubing could be used. The wiring extends through an end 252 of the tube 248, from which the wiring is separated into its component pairs of wires 242.

An end 256 of the tube 248 is inserted through an optional stabilizing collar 258 that rests upon the inner surface 260 and/or fits into a recess 262 formed by the closed neck 218 of the balloon 214. The collar 258 has an opening or hole 264 through which the balloon 214 can be inflated. The collar 258 is made, for example, of plastic or other lightweight material sufficiently stiff to provide stabilization for the tube 248. In the illustrated embodiment, the collar 258 is shown as a discrete component separate from the tube 248. Alternative embodiments, however, include the tube and collar being integrated or having a monolithic construction.

In the embodiment shown in FIG. 3, the light sources 226 are disposed relative to (e.g., mounted in, etc.) projection members 270. The projection members 270 are configured to project light from the light sources 226 onto the balloon inner surface 260. For example, as shown in FIG. 3, a projection surface 272 of each projection member 270 has a shape 274 through which light projects. The shape 274 may be an aperture in the surface 272, writing, a graphic, text, a shape, or other indicia having a color and/or light transmissibility different from that of the surface 272. Accordingly, the shape 274 is projected by the light source 226 onto and through the balloon 214 as a projection 276. Projection members 270 may be made, for example, of lightweight plastic or other suitable material sufficiently flexible to be inserted through the inflation opening 218 of the balloon 214. The projection members 270 may also comprise a suitable lens material (e.g. a resin, etc.) positioned generally over a light source 226. As another example, the projection members 270 may comprise a resin lens positioned generally over a light source 226 for altering the light. The projection surface 272 may be flat and/or curved. The projection members 270 may comprise a frosted dome-like member positioned generally over a light source 226. The projection surface 272 may be flat and/or curved. The surface 272 may be opaque, transparent, translucent, or a combination thereof.

When the balloon apparatus 200 is in use, a user grasps the control chip 230 and activates the switch 234 to provide power to the light sources 226. The user may also twist the control chip 230 and wiring 228 to cause the light sources 226 to turn within the balloon.

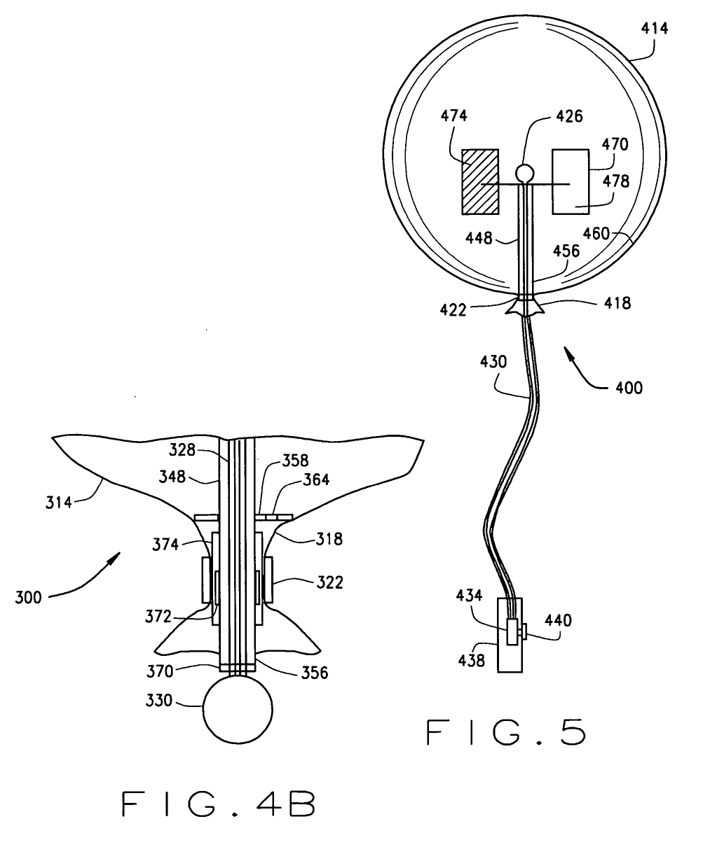

FIGS. 4A and 4B illustrate another exemplary embodiment of a balloon apparatus 300 embodying one or more aspects of the present disclosure. The balloon apparatus 300 includes an inflated balloon 314 having an inflation opening 318 that is closed for keeping the balloon 314 inflated. As shown in FIG. 4A, the balloon 314 is a latex-based balloon, and the inflation opening 318 is a neck that is closed, for example, using a clip 322. In other embodiments, the balloon may be fabricated of Mylar® or other material. The balloon 314 may be translucent, transparent, and/or have opaque portions. In other embodiments, the balloon may be fabricated of Mylar® or other material, and may have, for example, a translucent or transparent panel or window through which illumination may be visible. In some embodiments, the balloon can be black-light sensitive. In other embodiments, embodiments, one or more portions of the balloon may be black-light responsive or sensitive. For example, patterns, text, logos, other indicia, etc. may be imprinted on the balloon in black-light sensitive dye.

The clip 322 in one embodiment is made of metal or plastic and completely encircles the opening 318, in the manner of a “slap” bracelet-like fashion, with sufficient spring tension to prevent or inhibit deflation of the balloon 314. The clip 322 may include grooves into which an end of the clip is pushed to lock the clip. Alternatively, other closing devices may be used instead of the clip 322, such as a resilient gasket or ring, etc. The clip 322 (or other suitable closing device) is configured to seal the balloon 314 sufficiently to keep the balloon 314 inflated, for example, for as long as one or two days while accommodating a tube and sleeve extending through the opening 318 as further described below.

A plurality of light sources 326, for example, two light sources 326, inside the balloon 314 are electrically connected via wiring 328 to a power source, for example, a control chip 330 the same as or similar to the chip 230 (shown in FIG. 3). In the illustrated embodiment, the light sources 326 are light-emitting diodes (LEDs), although other suitable light sources could be used (e.g., black light sources, etc.).

The wiring 328 includes a plurality of pairs of insulated wires 342, each pair electrically connecting a corresponding light source 326 with the power source 330. The wiring 328 extends from the light sources 326 through the closed neck 318 to the power source 330.

In the present embodiment, the wiring 328 extends through a hollow tube 348 extending through the balloon neck 318. The tube 348 is made, for example, of a lightweight plastic tubing the same as or comparable to that used in fabricating soda straws, although other suitable types of tubing could be used.

An end 356 of the tube 348 is inserted through a stabilizing collar 358 that rests upon the inner surface 360 and/or fits into a recess 362 formed by the closed neck 318 of the balloon 314. The collar 358 has an opening or hole 364 through which the balloon 314 can be inflated. In the illustrated embodiment, the collar 358 is shown as a discrete component separate from the tube 348. Alternative embodiments, however, include the tube and collar being integrated or having a monolithic construction.

A sleeve 374 fits over the tube 348. The sleeve 374 can also at least partially support the clip 322.

In the embodiment shown in FIG. 4A, each light source 326 are disposed relative to (e.g., mounted in, etc.) a diffusion member 370. The diffusion members 370 are configured to diffuse light from the light sources 326. Diffusion members 370 may include translucent balloons and/or other translucent material (e.g., lightweight plastic), among other possible items. Diffusion members 370 may have various shapes and sizes, may include writing, designs, and textures and can be particularly effective where the balloon 314 is transparent. Although each diffusion member 370 in the embodiment shown in FIG. 4A diffuses light of a single light source 326, other embodiments can include more than one light source 326 disposed relative to (e.g., mounted in, etc.) a single diffusion member 370. Further embodiments can also include one or more light sources that are not associated with a diffusion member. Generally, it is contemplated in connection with the embodiments described herein that a plurality of light sources can be grouped together for projection, diffusion, and the like.

FIG. 4B provides a more detailed partial cross-sectional view of the balloon apparatus 300. As shown in FIG. 4B, the tube end 356 is closed by a gas-tight plug or seal 370, for example, of glue or adhesive, through which the wiring 328 extends for connection with the power supply 330. The seal 370 alternatively may be at the other end of, or inside, the tube 348, to prevent or inhibit the escape of gas from the inflated balloon through the tube 348. The wiring in one embodiment is embedded in the seal.

A gasket 372 of rubber or other suitable flexible material fits snugly around the tube 348. The sleeve 374 fits around the gasket 372 and tube 348. The clip 322 fits tightly enough around the neck 318 and sleeve 374, for example, in “slip bracelet”-like fashion to prevent or inhibit the escape of gas from the balloon 314. The gasket 372 fits tightly enough around the tube 348 to prevent or inhibit the escape of gas from the balloon around the tube 348, but is also sufficiently flexible to allow the tube 348 to be moved by a user holding and turning the tube end 356. When the balloon apparatus 300 is in use, a user grasping the tube end 356 can twist, spin, push, and/or pull the tube 348 to cause the light sources 326 to move in various ways. For example, some embodiments can allow the user to slide the tube 348 inward or outward relative to the gasket 372, sleeve 374, and clip 322.

FIG. 5 illustrates another exemplary embodiment of a balloon apparatus 400 embodying one or more aspects of the present disclosure. The apparatus 400 includes an inflated balloon 414 having an inflation opening 418 that is closed for keeping the balloon 414 inflated. As shown in FIG. 5, the balloon 414 is a latex-based balloon, and the inflation opening 418 is a neck that is closed, for example, using a plastic clip 422. Alternatively, other closing devices may be used instead of the clip 422, such as a resilient gasket or ring, etc. In addition, balloon 414 may be translucent, transparent, and/or have opaque portions. In other embodiments, the balloon may be fabricated of Mylar® or other material, and may have, for example, a translucent or transparent panel or window through which illumination may be visible. In some embodiments, the balloon can be black-light sensitive. In other embodiments, embodiments, one or more portions of the balloon may be black-light responsive or sensitive. For example, patterns, text, logos, other indicia, etc. may be imprinted on the balloon in black-light sensitive dye.

With continued reference to FIG. 5, a light source 426 inside the balloon 414 is electrically connected via wiring 430 to a power source 434, for example, a battery enclosed in a casing 438 and operable via an off/on switch 440. In the present embodiment, the light source 426 includes one or more light-emitting diodes (LEDs), although other suitable light sources could be used (e.g., black light sources, etc.). The wiring 430 extends from the light source 426 through the closed neck 418 to the power source 434.

The wiring 430 extends through a hollow tube 448 that is enclosed in the balloon 414. The tube 448 is made, for example, of a lightweight plastic tubing the same as or comparable to that used in fabricating soda straws, although other suitable types of tubing could be used. An end 456 of the tube 448 rests upon the inner surface 460 of the balloon near or over the closed inflation opening 418. In another embodiment, a collar the same as or similar to the collar 258 (shown in FIG. 3) may be used to stabilize the tube 448.

As shown in FIG. 5, a pair of spaced-apart flags 470 is configured to rotate freely about the light source 426. Each flag 470 includes, for example, a black side 474 and a silver side 478. Accordingly, the flags 470 are configured to rotate, and thus to perform in the manner of a radiometer under radiant power, for example, from the power source 426, from the sun, and/or from an indoor lamp. Although black and silver coloring is preferred, the flags 470 may have various colors, shapes, and sizes.

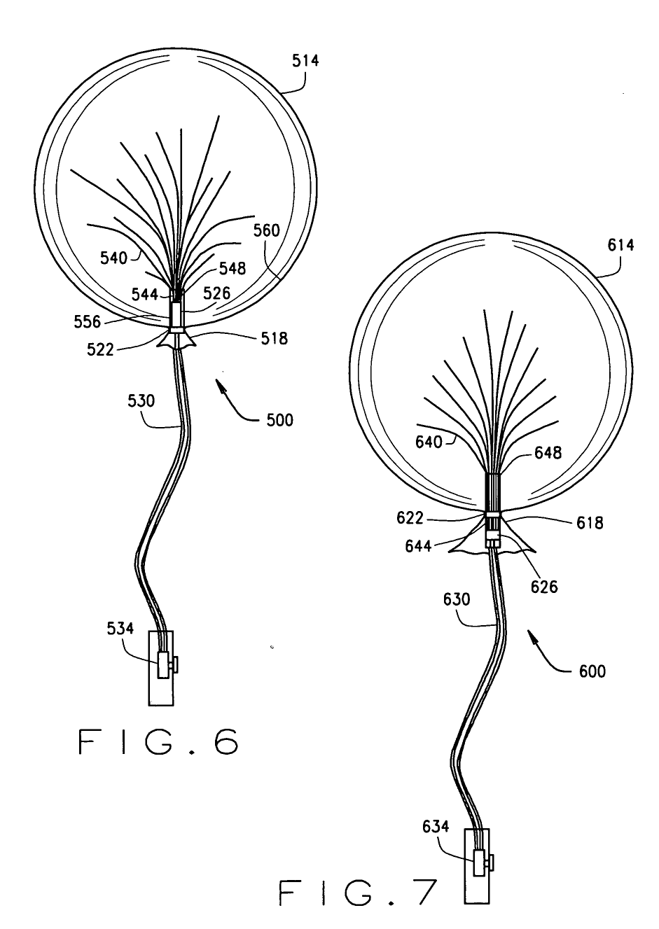

FIG. 6 illustrates another exemplary embodiment of a balloon apparatus 500 embodying one or more aspects of the present disclosure. The apparatus 500 includes an inflated balloon 514 having an inflation opening 518 that is closed for keeping the balloon 514 inflated. As shown in FIG. 6, the balloon 514 is a latex-based balloon, and the inflation opening 518 is a neck that is closed, for example, using a plastic clip 522. Alternatively, other closing devices may be used instead of the clip 522, such as a resilient gasket or ring, etc. In addition, the balloon 514 may be translucent, transparent, and/or have opaque portions. In other embodiments, the balloon may be fabricated of Mylar® or other material, and may have, for example, a translucent or transparent panel or window through which illumination may be visible. In some embodiments, the balloon can be black-light sensitive. In other embodiments, embodiments, one or more portions of the balloon may be black-light responsive or sensitive. For example, patterns, text, logos, other indicia, etc. may be imprinted on the balloon in black-light sensitive dye.

A light source 526 inside the balloon 514 is electrically connected via wiring 530 to a power source 534. In the present embodiment, the light source 526 includes one or more light-emitting diodes (LEDs), although other suitable light sources could be used (e.g., black light sources, etc.). The wiring 530 extends from the light source 526 through the closed neck 518 to the power source 534.

A plurality of optical fibers 540 have ends 544 that are gathered and aligned so as to fit closely together directly over the light source 526, and such that a focal point of the light source 526 matches the fiber ends 544. The optical fibers 540 and light source 526 have a diameter, for example, of about five millimeters. Alternatively, larger and/or smaller optical fibers can be used in other embodiments.

The fiber ends 544 are affixed generally over the light source 526 by a tube 548. The fibers 540 are permitted to fan out freely above the tube 548 and can have various lengths, depending on a desired display and particular balloon size.

An end 556 of the tube 548 rests upon the inner surface 560 of the balloon 514 near or over the closed inflation opening 518. The tube 548 is fabricated, for example, of heat shrink material applied around the wiring 530, light source 526, and fiber ends 544 and blow-dried to shrink the material. Other suitable types of tubing could be used in place of, or in addition, to heat shrink material. The tube 548 can be of various lengths, depending on, for example, a height at which the optical fibers are desired to fan out above the tube 548. When the tube 548 is fabricated of heat shrink material, one particular embodiment has about a one-half-inch length of the tube 548 that serves to hold the fiber ends 544 in place above the light source 526. The tube 548 could also be fabricated, for example, of clear plastic and could have a length of up to about two inches. Alternatively, other lengths can be used depending on the particular application, such as the balloon size.

When the apparatus 500 is in use, the optical fibers 540 emit points of light that move with the fibers 540. Where the balloon 514 is transparent, the points of light are relatively clearly visible. Where the balloon 514 is translucent, the light can appear as a soft glow. In those embodiments that include a black light source, the black light source can emit black light that is emitted as points of light that move with the fibers. The black light emitted out the fibers can then cause one or more black-light-sensitive portion(s) of the balloon to glow or illuminate.

FIG. 7 illustrates another exemplary embodiment of a balloon apparatus 600 embodying one or more aspects of the present disclosure. The balloon apparatus 600 includes a balloon 614 having a neck 618 that is closed by a clip 622, preferably a “slip bracelet”-like, spring-tensioned clip having sufficient length to encircle and lock around the neck 618 and a tube extending through the neck 618. Alternatively, other closing devices may be used instead of the clip 622, such as a resilient gasket or ring, etc.

As shown in FIG. 7, the balloon 614 is a latex-based balloon. The balloon 614 may be translucent, transparent, and/or have opaque portions. In other embodiments, the balloon may be fabricated of Mylar® or other material, and may have, for example, a translucent or transparent panel or window through which illumination may be visible. In some embodiments, the balloon can be black-light sensitive. In other embodiments, embodiments, one or more portions of the balloon may be black-light responsive or sensitive. For example, patterns, text, logos, other indicia, etc. may be imprinted on the balloon in black-light sensitive dye.

A light source 626 outside the balloon 614 is connected via wiring 630 to a power source 634. A plurality of optical fibers 640 have ends 644 that are gathered and aligned so as to fit closely together directly over the light source 626, and such that a focal point of the light source 626 matches the fiber ends 644. The fiber ends 644 are affixed generally over the light source 626 by a tube 648 extending over the light source 626 and into the balloon 614 through the neck 618. The fibers 640 are permitted to fan out freely above the tube 648 and can have various lengths, depending on a desired display and/or particular balloon size.

The tube 648 is fabricated, for example, of heat shrink material applied around the wiring 630, light source 626, and fiber ends 644 and blow-dried to shrink the material. Other suitable types of tubing could be used in place of or in addition to heat shrink material, including but not limited to clear plastic tubing.

When the apparatus 600 is in use, the optical fibers 640 emit points of light that move with the fibers 640. Where the balloon 614 is transparent, the points of light are relatively clearly visible. Where the balloon 614 is translucent, the light can appear as a soft glow. In those embodiments that include a black light source, the black light source can emit black light that is emitted as points of light that move with the fibers. The black light emitted out the fibers can then cause one or more black-light-sensitive portion(s) of the balloon to glow or illuminate.

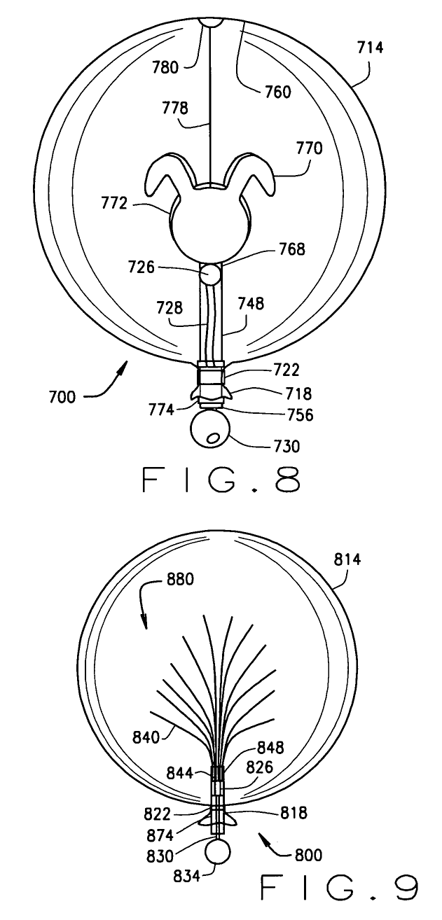

FIG. 8 illustrates another exemplary embodiment of a balloon apparatus 700 embodying one or more aspects of the present disclosure. The apparatus 700 includes an inflated balloon 714 having an inflation opening 718 that is closed for keeping the balloon 714 inflated. As shown in FIG. 8, the balloon 714 is a latex-based balloon, and the inflation opening 718 is a neck that is closed, for example, using a clip 722. The clip 722 in one embodiment is made of plastic or metal and completely encircles the opening 718 in “slip bracelet”-like fashion, with sufficient spring tension to prevent or inhibit deflation of the balloon. Alternatively, other closing devices may be used instead of the clip 722, such as a resilient gasket or ring, etc.

In addition, the balloon 714 may be translucent, transparent, and/or have opaque portions. In other embodiments, the balloon may be fabricated of Mylar® or other material, and may have, for example, a translucent or transparent panel or window through which illumination may be visible. In some embodiments, the balloon can be black-light sensitive. In other embodiments, embodiments, one or more portions of the balloon may be black-light responsive or sensitive. For example, patterns, text, logos, other indicia, etc. may be imprinted on the balloon in black-light sensitive dye.

The clip 722 (or other suitable closing device) is configured to seal the balloon 714 sufficiently to keep the balloon inflated, for example, for as long as one or two days while accommodating a tube extending through the opening 718.

A light source 726 inside the balloon 714 is electrically connected via wiring 728 to a power source, for example, a control chip 730 the same as or similar to the chip 230 (shown in FIG. 3). In the present embodiment, the light source 726 is a light-emitting diode (LED), although other suitable light sources could be used (e.g., black light source, etc.). The wiring 728 extends through a hollow tube 748. The tube 748 supports the light source and extends through the balloon neck 718. The tube 748 is made, for example, of a lightweight plastic tubing comparable to that used in fabricating soda straws. A sleeve 774 fits over the tube 748.

An end 768 of the tube supports a display member 770 adjacent the light source 726. The display member 770 is fabricated, for example, of thin (e.g., one-eighth-inch), flexible soft vinyl or plastic and may be wholly or partially transparent, translucent, opaque and/or black light sensitive. The display member 770 shown in FIG. 8 is substantially flat and transparent and has thin and/or etched edges 772. Light from the light source 726 is transmitted through the display member 770 and can appear as a glowing border along the edges 772.

In other embodiments, the display member 770 can also include a light altering device, such as a prismatic or faceted member for reflecting, diffusing, diffracting, refracting, etc. light from the light source 726. Or, for example, the display member 770 may include a light-conducting material having one or more indicia (e.g., etched indicia, etc.). This light-conducting material may be configured to receive and conduct light from the light source 726 to at least one side edge portion of the indicia for highlighting the indicia. In some embodiments, the light-conductive material may be configured to inhibit light from inadvertently escaping out of the light-conducting material portion thereby increasing the amount of available light for highlighting the indicia.

In those embodiments that include a black light source (e.g., black light LED, etc.), the black light source can emit black light that causes a black-light sensitive portion(s) of the display member 770 to glow inside the balloon 714. Alternative embodiments include light sources that do not emit black lights in addition to or as an alternative to a black light source. In such embodiments, the balloon and/or the display member can be configured such that the balloon does not include any black-light-sensitive portions.

Depending, for example, on the weight and/or shape of a display member, it may be desirable to provide support for the display member relative to the balloon inner surface. Generally, various member(s), for example, thread(s), wire(s), and/or stalk(s), may be used to support and/or suspend a display member relative to an inflated object in various embodiments of the present disclosure. Accordingly and for example, an optional member 778 for example, a thread, is affixed between the balloon inner surface 760 and the display member 770. The thread 778 may be elastic and/or may be black-light sensitive. Adhesive 780 may be used to affix the thread 778 to the balloon inner surface 760.

The display member 770 may have various shapes and sizes, may include printed designs, writing, textured, glowing and/or reflective areas, and can be particularly effective where the balloon 714 is transparent. A display member 770 presented in three dimensions, for example, a clear and/or reflective pyramid, disco ball, or other object, can transmit and/or reflect light from the light source 726 in many interesting ways and is attractive when viewed from any direction.

It is contemplated that each of a plurality of display members could be supported adjacent a corresponding light source. For example, a pair of display members 770 could be supported adjacent a pair of opposed light sources similar to the light sources 326 (shown in FIG. 4A). Such display members can be arranged so that light is transmitted and/or reflected from one to another display member, thereby increasing the play of light within and through the balloon.

The balloon apparatus 700 is sealed in the same or a similar manner as the balloon apparatus 300 (shown in FIGS. 4A and 4B). Accordingly, the sleeve 774 fits around the tube 748, supports the clip 722, and also allows the tube 748 to be moved by a user holding and turning an end 756 of the tube 748. When the balloon apparatus 700 is in use, a user grasping the tube end 756 can twist, spin, push and/or pull the tube 748 to cause the light source 726 and the display member(s) to move in various ways. For example, some embodiments can allow the user to slide the tube 748 inward or outward relative to the sleeve 774 and clip 722.

FIG. 9 illustrates another exemplary embodiment of a balloon apparatus 800 embodying one or more aspects of the present disclosure. The apparatus 800 includes an inflated balloon 814 having an inflation opening 818 that is closed for keeping the balloon 814 inflated. As shown in FIG. 9, the balloon 814 is a latex-based balloon, and the inflation opening 818 is a neck that is closed, for example, using a plastic clip 822.

Alternatively, other closing devices may be used instead of the clip 822, such as a resilient gasket or ring, etc. In addition, the balloon 814 may be translucent, transparent, and/or have opaque portions. In other embodiments, the balloon may be fabricated of Mylar® or other material, and may have, for example, a translucent or transparent panel or window through which illumination may be visible. In some embodiments, the balloon can be black-light sensitive. In other embodiments, embodiments, one or more portions of the balloon may be black-light responsive or sensitive. For example, patterns, text, logos, other indicia, etc. may be imprinted on the balloon in black-light sensitive dye.

A light source 826 inside the balloon 814 is electrically connected via wiring 830 to a power source 834. In the present embodiment, the light source 826 includes one or more light-emitting diodes (LEDs), although other suitable light sources could be used (e.g., black light sources, etc.). The wiring 830 extends from the light source 826 through the closed neck 818 to the power source 834. The power source 834 may be a chip that provides various functions, such as strobing, blinking, causing different LEDs to emit different colors, etc.

A plurality of optical fibers 840 have ends 844 that are gathered and aligned so as to fit closely together directly to form an optical fiber member 880 generally over the light source 826, and such that a focal point of the light source 826 matches the fiber ends 844. The optical fibers 840 and light source 826 have a diameter, for example, of about five millimeters. Alternatively, larger and/or smaller optical fibers can be used in other embodiments.

The fiber ends 844 are affixed over the light source 826 by a tube 848. The fibers 840 are permitted to fan out freely above the tube 848 and can have various lengths, depending on a desired display.

The tube 848 is fabricated, for example, of heat shrink material applied around the wiring 830, light source 826, and fiber ends 844 and blow-dried to shrink the material. Other suitable types of tubing could be used in place of or in addition to heat shrink material. The tube 848 can be of various lengths, depending on, for example, a height at which the optical fibers are desired to fan out above the tube 848. The tube 848 could also be fabricated, for example, of clear plastic.

In this illustrated embodiment, the balloon apparatus 800 is sealed in the same or a similar manner as the balloon apparatus 300 (shown in FIGS. 4A and 4B). Accordingly, the sleeve 874 fits around the tube 848 and supports the clip 822, and allows the tube 848 to be moved by a user holding and turning an end of the tube 848.

When the balloon apparatus 800 is in use, a user grasping the tube end can twist, spin, push and/or pull the tube 848 to cause the light source 826 and the display member to move in various ways. For example, some embodiments can allow the user to slide the tube 848 inward or outward relative to the sleeve 874 and clip 822.

The user can also use the control chip 834, for example, to turn the light source on and off and cause the light source to emit different colors, to strobe, and/or perform such functions as may be available via the chip 834. The optical fibers 840 emit points of light that move with the fibers. Where the balloon 814 is transparent, the points of light are clearly visible. Where the balloon 814 is translucent, the light can appear as a soft glow. In those embodiments that include a black light source, the black light source can emit black light that is emitted as points of light that move with the fibers. The black light emitted out the fibers can then cause one or more black-light-sensitive portion(s) of the balloon to glow or illuminate.

FIG. 10 illustrates another exemplary embodiment of a balloon apparatus 900 embodying one or more aspects of the present disclosure. The apparatus 900 includes an inflated balloon 914 having a neck 918 that is closed via a plastic clip 922. The clip 922 (or other suitable closing device) is configured to seal the balloon 914 sufficiently to keep the balloon inflated, for example, for as long as one or two days while accommodating electrical wiring extending through the opening 918 as further described below. The clip 922 may be one of several clips commonly available for sealing balloons.

As shown in FIG. 10, the balloon 914 is a latex-based balloon. The balloon 814 may be translucent, transparent, and/or have opaque portions. In other embodiments, the balloon may be fabricated of Mylar® or other material, and may have, for example, a translucent or transparent panel or window through which illumination may be visible. In some embodiments, the balloon can be black-light sensitive. In other embodiments, embodiments, one or more portions of the balloon may be black-light responsive or sensitive. For example, patterns, text, logos, other indicia, etc. may be imprinted on the balloon in black-light sensitive dye.

Electroluminescent wire 930 connected to a power source 934 extends through the closed neck 918 into the balloon 914, wherein the wire 930 is shaped to form a display member 938. In the embodiment shown in FIG. 10, a clear coating or tubing 944 extends between the power source 934 and the display member 938. The tubing 944 surrounds and constrains the wire 930 to form a single strand 946. When the wire 930 receives power from the power source 934, the wire 930 and display member 938 become a light source that provides light inside and outside the balloon 914. The wire 930 may have a “memory” such that the wire is flexible yet can retain a shape into which it is formed. Accordingly, in other embodiments, the tubing 944 may be at least partially omitted where, for example, portions of the wire 930 are twisted together to form a single strand.

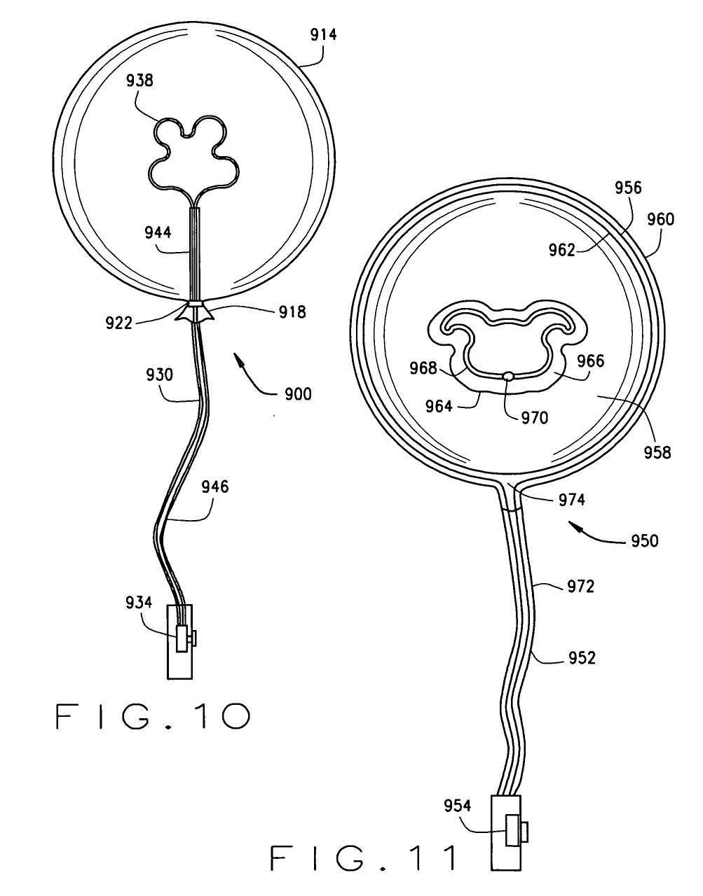

FIG. 11 illustrates another exemplar embodiment of a balloon apparatus 950 embodying one or more aspects of the present disclosure. The balloon apparatus 950 includes at least one electroluminescent light source 952 (e.g., electroluminescent wire, electroluminescent sheeting, etc.) that extends from a power source 954 to form a display member 956 around a Mylar® balloon 958. The display member 956 is enclosed, for example, in a clear casing 960 formed by turning over and sealing a seam 962 at which halves of the balloon 958 are joined together. When the power source 954 is activated, the wire 952 and display member 956 both provide light.

Alternatively, other embodiments can include additional or alternative light sources (e.g., LEDs, chemiluminescent light sources, black light sources, etc.) disposed within the casing 960 at least partially formed by the seam 962. Further embodiments can also include a casing at least partially formed by a seam internal to or within the balloon. By way of example, various embodiments include an internal or external pocket or pouch at least partially formed by a corresponding internal or external seam, where at least one light source (e.g., glow stick, LED array, electroluminescent light source, LED, chemiluminescent light source, etc.) is disposed within the pouch or pocket.

In FIG. 11, the seam 962 is shown as a generally continuous seam extending uninterrupted generally along a periphery of the balloon 958. In addition, electroluminescent light source 952 is also shown generally continuously extending uninterrupted within the seam 962. In other embodiments, however, a balloon may include one or more non-continuous seams extending along less than the entire periphery of the balloon. In such embodiments, one or more electroluminescent light sources (or other suitable light sources) may be positioned within one or more of those non-continuous seams. In yet other embodiments, a balloon may include a generally continuous seam extending along a periphery of the balloon, with one or more electroluminescent light sources disposed along or spaced apart within that seam.

With continued reference to FIG. 11, the illustrated balloon 958 also includes a display member 964. The display member 964 includes a sticker 966 that is clear and/or translucent at least in part, such that electroluminescent light source 968, (e.g., electroluminescent wire, etc.) beneath the sticker 966 can be visible. The sticker 966 is applied over the electroluminescent light source 968 and onto the balloon 958.

In other embodiments, an electroluminescent light source, such as electroluminescent wire or electroluminescent sheeting material, includes a sticky backing such that the electroluminescent light source can be applied directly onto the balloon. The electroluminescent light source (e.g., electroluminescent wire 968, etc.) can be connected to a power supply, such as a button battery 970 and/or power supply 954 similar to the exemplary manner shown in FIG. 11. In the particular embodiment shown in FIG. 11, clear tubing 972 constrains the wire 952 between the power source 954 and a closure member 974.

In some embodiments, a balloon apparatus includes one or more electroluminescent light sources (e.g., electroluminescent wire, electroluminescent sheeting materials, etc.) positioned generally between an inner balloon layer and an outer balloon layer. Additional embodiments include one or more electroluminescent sheeting materials disposed within and applied to one or more inner surface portions of the balloon. Further embodiments include one or more electroluminescent sheeting materials applied to one or more outer surface portions of the balloon.

Still further embodiments include one or more electroluminescent light sources that are integrally formed (e.g., printed, etc.) as part of the material forming the balloon or other inflated/inflatable object. For example, some embodiments include a Mylar balloon having electroluminescent light sources integrally printed or otherwise formed with the Mylar material. In which case, the balloon (or other inflated/inflatable object) itself comprises the light source. Alternative embodiments can include a latex balloon having electroluminescent light sources integrally printed or otherwise formed with the latex material. In which case, the balloon (or other inflated/inflatable object) itself comprises the light source.

In various embodiments, the light source may be powered by at least one power source disposed within the balloon itself, such as within the neck through which the balloon is inflatable. In such embodiments, a user may be able to switchably connect the light source to the battery by squeezing the neck to activate/deactivate a switching device (e.g., push-button switch, etc.) also disposed within the neck. The switch may also allow the user to cycle through the various display modes or select a particular color for the at least one light source by successively squeezing the neck. Additionally, the switch may also allow the user to dim or brighten the intensity of the light, for example, by holding down the switch with continuously applied pressure to the neck.

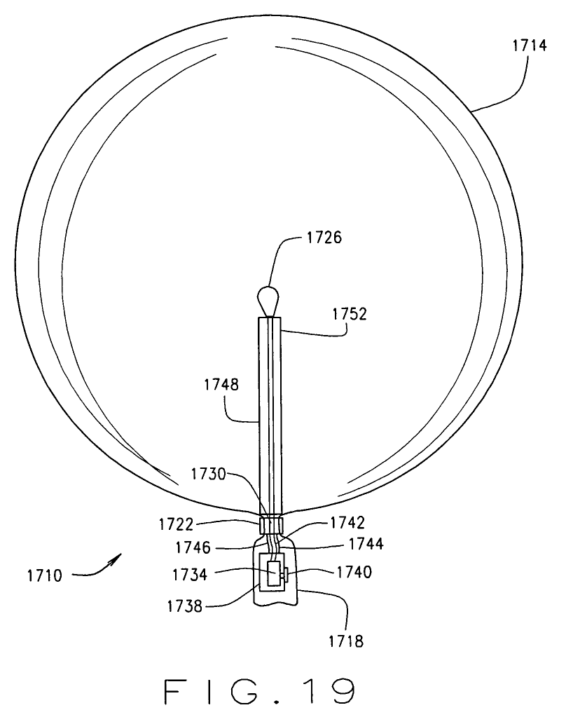

For example, FIG. 19 illustrates an exemplary balloon apparatus 1710 embodying one or more aspects of the present disclosure. As shown in FIG. 19, the balloon apparatus 1710 includes an inflated balloon 1714 having an inflation opening 1718 that is closed for keeping the balloon 1714 inflated. In this particular embodiment, the balloon 1714 is a latex-based balloon, and the inflation opening 1718 is a neck that is closed, for example, using a plastic clip 1722. In other embodiments, the balloon may be fabricated of Mylar® or other material, and may have, for example, a translucent or transparent panel or window through which illumination may be visible. In some embodiments, the balloon can be black-light sensitive. In other embodiments, embodiments, one or more portions of the balloon may be black-light responsive or sensitive. For example, patterns, text, logos, other indicia, etc. may be imprinted on the balloon in black-light sensitive dye.

A light source 1726 inside the balloon 1714 is electrically connected via wiring 1730 to a power source 1734, for example, a battery enclosed in a casing 1738 and operable via an off/on switch 1740. In this particular embodiment, the power source 1734 and the switch 1740 are positioned within the neck 1718. Accordingly, a user can activate/deactivate the switching device 1740 (e.g., push-button switch, etc.) to thereby turn on/off the light source 1726 by squeezing the neck 1718. The switch 1740 may also allow the user to cycle through the various display modes or select a particular color for the at least one light source 1726 by successively squeezing the neck 1718. Additionally, the switch 1740 may also allow the user to dim or brighten the intensity of the light, for example, by holding down the switch 1740 with continuously applied pressure to the neck 1718.

The wiring 1730 can include a pair of insulated wires 1742 encased together in a coating 1744 to form a single strand 1746. The wiring 1730 extends from the light source 1726 to the power source 1734 within the neck 1718.

The wiring 1730 extends through a hollow tube 1748 that is enclosed in the balloon 1714. The tube 1748 is made, for example, of a lightweight plastic tubing the same as or comparable to that used in fabricating soda straws, although other suitable types of tubing could be used. An end 1752 of the tube supports the light source 1726, which, in the illustrated embodiment, is fixedly mounted in the end 1752. In this particular embodiment, the light source 1726 is a light-emitting diode (LED. Alternatively, other suitable light sources can also or instead be used, such as incandescent, ultraviolet, black light, and/or fluorescent light sources.

The LED 1726 can be black-light emitting, and the balloon 1714 may be black-light sensitive or include black-light sensitive portions. Generally, light sources described in connection with various embodiments of the present disclosure may include a black-light emitting light source, and balloons and/or other balloon apparatus components described in connection with various embodiments may be black-light sensitive at least in part. Alternative embodiments include light sources that do not emit black lights in addition to or as an alternative to the black light source. In such embodiments, a balloon can be configured such that the balloon does not include any black-light-sensitive portions.

A person desiring to assemble a balloon apparatus may find a kit useful for making a balloon apparatus. Accordingly, various embodiments provide a kit for making a balloon apparatus. In such embodiments, a kit includes a balloon having an opening through which the balloon is inflatable. The opening is sealable to keep the balloon inflated. The kit also includes a light source insertable within the balloon, and a power source connectable to the light source via conductive wiring. The kit can also include a tube through which the wiring is extendable. The tube can be configured to fit inside the balloon and support the light source when the balloon is inflated and the opening is sealed. Such a kit could also include one or more display member(s), diffusion member(s), projection member(s), and/or optical fiber member(s). In addition, any one or more components within such a kit may include a black-light sensitive portion, and the kit may also include a black light source (e.g., black light LED, etc.).

Another embodiment of a kit for making a balloon apparatus includes a balloon having a neck through which the balloon is inflatable. The neck is sealable to keep the balloon inflated. The kit also includes a light source insertable into the balloon, and a power source connectable to the light source via wiring. The kit can also include a gas-tight tube through which the wiring extends. The tube can have one end insertable into the balloon and configured to support the light source. The tube can be further configured to extend outside the balloon when the balloon is inflated and the neck is sealed. A clip can be provided for sealing the neck. A sleeve can be provided for fitting over the tube. The sleeve can be configured to support the clip to prevent or inhibit deflation of the balloon when the clip is applied to the neck. The sleeve can be further configured to permit movement of the tube by a user to move the light source within the inflated balloon. For example, some embodiments can allow the user to slide the tube inward or outward relative to the balloon, sleeve, and clip. In addition, any one or more components within such a kit may include a black-light sensitive portion, and the kit may also include a black light source (e.g., black light LED, etc.).

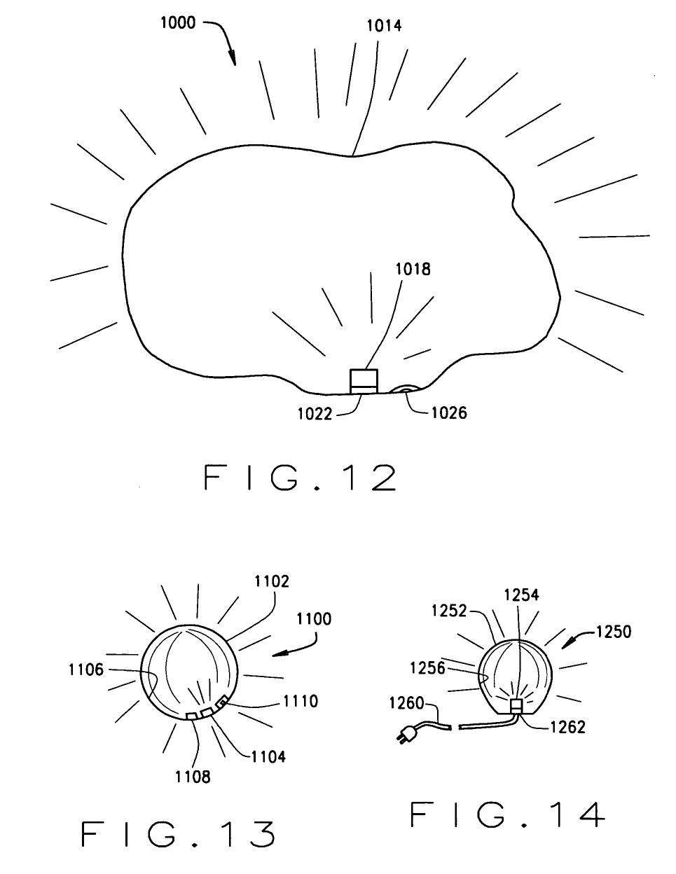

FIG. 12 illustrates an exemplary embodiment of a lighted fluid-inflated object 1000 embodying one or more aspects of the present disclosure. The object 1000 may be, for example, a gas-filled or liquid-filled balloon, a ball, a lamp, a support for a body, a support for a body part, a raft, and/or an item of furniture. As shown in FIG. 12, the object 1000 has a skin 1014, at least a portion of which can be reactive, responsive, or sensitive to black light. The object 1000 also includes a light source 1018 positioned so as to illuminate at least a portion of the skin 14. In various embodiments, the light source 1018 comprises a black-light source 1018 (e.g., a black-light LED, other black-light sources, etc.). Alternative embodiments can include one or more light sources that do not emit black lights in addition to or as an alternative to the black light source 18.

The light source 1018 is electrically powered by a power supply 1022, such as a battery, among other suitable power sources (e.g., solar panels, electrical cords, etc.). In the illustrated embodiment of FIG. 12, the power source 1022 is disposed within the interior defined by the skin 1014 of the inflated object 1000. Alternative embodiments can include one or more power sources at least partly external or outside of the interior defined by the skin 1014.

FIG. 12 also shows the light source 1018 disposed within the interior defined by the skin 1014. Alternative embodiments can include one or more light sources disposed at least partly outside or external to the interior defined by the skin 1014.

The skin 1014 can be fabricated, for example, at least in part of plastic, polyvinyl chloride (PVC), latex, and/or other materials, such as materials fabricated and/or treated so as to be black-light sensitive or responsive/reactive to black light. Exemplary materials that are responsive to black light include plastic materials containing phosphor (e.g., Zinc Sulfide, Strontium Aluminate, etc.) and fluorescent materials.

The skin 1014 may be transparent, translucent, opaque, combinations thereof. For example, the skin 1014 may have a combination of transparent, translucent, and/or opaque areas, depending, for example, on a particular lighting effect that is desired using the light source 1018. The object 1000 can be inflated with a gas or liquid via a closeable inflation aperture 1026. In one embodiment, the aperture 1026 may be a sealable valve. In other embodiments, an inflatable object may be inflated by other means, such as inflating an object through a self-sealing skin, etc.

FIG. 13 illustrates an exemplary embodiment of an inflated or inflatable ball 1100. The ball 1100 has a transparent or translucent skin 1102, which may be at least partially black-light sensitive. A black light source 1104 (e.g., a black-light emitting LED, other black light sources, etc.) is attached to an inner surface 1106 of the ball 1100. Alternative embodiments include light sources that do not emit black lights in addition to or as an alternative to the black light source 1104. In such embodiments, the ball can be configured such that the ball does not include any black-light-sensitive portions.

Continuing with the embodiment shown in FIG. 13, a battery 1108 is affixed to the inner surface 1106 and is electrically connected to the LED 1104. The ball 1100 is inflated via an inflation valve 1110. The battery 1108 may be configured to switch off or on in response to pressure applied to the ball 1100, for example, when the ball 1100 is bounced by a user against a hard surface.

FIG. 14 illustrates an exemplary embodiment of an inflated or inflatable lamp 1250 embodying one or more aspects of the present disclosure. As shown, the lamp 1250 has an inflatable transparent or translucent skin 1252, at least a portion of which is black-light sensitive. A black light source 1254 (e.g., a black-light emitting LED, other black light sources, etc.) is attached to an inner surface 1256 of the skin 1252. Alternative embodiments include light sources that do not emit black lights in addition to or as an alternative to the black light source 1254. In such embodiments, the lamp's skin can be configured such that the lamp's skin does not include any black-light-sensitive portions.

Continuing with the embodiment shown in FIG. 14, wiring 1260 extends from the LED 1254 through the skin 1252, through an aperture 1262 that is substantially fluid-tight with respect to the fluid inflating the lamp 1250. The wiring 1260 provides electric power to the LED 1254 via a wall outlet (not shown). In other embodiments, the lamp 1250 can be powered by a battery in addition to or as an alternative to receiving power via the wiring 1260 and wall outlet.

FIG. 15 illustrates an exemplary embodiment of an inflated or inflatable chair 1300 embodying one or more aspects of the present disclosure. As shown in this particular embodiment, the chair 1300 is inflated, for example, with air, water, among other suitable fluids. The chair 1300 has a transparent or translucent skin 1302, at least a portion of which is black-light sensitive. A battery 1304 is wired via wiring 1306 to a plurality of black-light LEDs 1308. Alternative embodiments include light sources that do not emit black lights in addition to or as an alternative to the black light sources 1308. In such embodiments, the chair can be configured such that the chair does not include any black-light-sensitive portions.

Continuing with the embodiment shown in FIG. 15, the battery 1304 is mounted outside the skin 1302 in a recess 1310 in the skin 1302 and can be switched on or off via a switch (not shown) outside the skin 1302. The wiring 1306 extends through the skin 1302 to the battery 1304. The skin 1302 is sealed relative to the wiring 1306 so that the skin 1302 remains inflated.

The LEDs 1308 are suspended from an inner surface 1314 of the skin 1302 via a plurality of threads 1318, which can be black-light sensitive. When the battery 1304 is switched on, the chair 1300 is illuminated by the LEDs 1308. In those embodiments that include black light LEDs 1308, the black light LEDs 1308 can emit black light after the power source has been switched on. Black light can then cause the black-light-sensitive portion(s) of the chair 1300 to glow or illuminate.

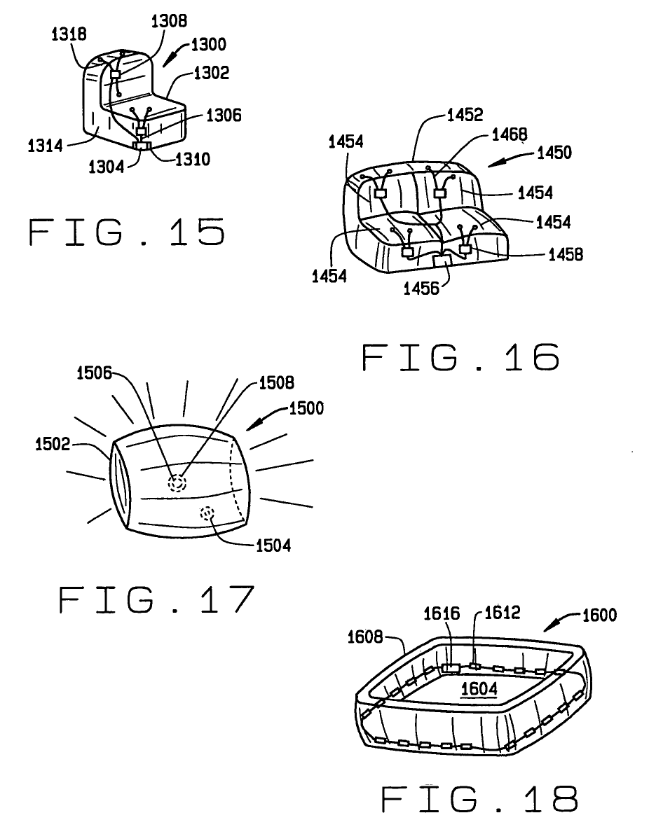

FIG. 16 illustrates an exemplary embodiment of an inflated or inflatable sofa 1450 embodying one or more aspects of the present disclosure. As shown in this particular embodiment, the sofa 1450 is inflated, for example, with air, water, among other suitable fluids. The sofa 1450 includes a skin 1452 having black-light sensitive backrest and seat panels 1454. A battery 1456 is wired to a plurality of black-light LEDs 1458. Alternative embodiments include light sources that do not emit black lights in addition to or as an alternative to the black light source 1458. In such embodiments, the sofa can be configured such that the sofa does not include any black-light-sensitive portions.

Continuing with the embodiment shown in FIG. 16, the battery 1456 is mounted beneath the sofa 1450 and can be switched on or off. The LEDs 1458 are suspended inside the skin 1452 via a plurality of threads 1468. The threads 1468 can be black-light sensitive. When the battery 1456 is switched on, the backrest and seat panels 1454 are illuminated by black light from the LEDs 1458. Alternative embodiments provide other black-light-illuminated inflatable furniture, such as beds, mattresses, and hassocks.

FIG. 17 illustrates an exemplary embodiment of an inflated or inflated pillow 1500 embodying one or more aspects of the present disclosure. As shown, the pillow 1500 has a skin 1502 fabricated of a transparent or translucent black-light sensitive material and is inflated via an inflation valve 1504 (shown in phantom). A black-light LED 1506 is mounted atop a battery 1508, which, in turn, is mounted inside the interior defined by the skin 1502 of the pillow 1500. A user presses through the skin 1502 to operate a battery button switch (not shown) to switch the battery 1508 on or off. Embodiments also are contemplated, wherein headrests and seat cushions, for example, for a sofa, chair, or car seat, are inflatable and black-light-illuminated. Black-light-illuminated swim rings for use in swimming pools, beaches, and the like also are contemplated.

FIG. 18 illustrates an exemplary embodiment of an inflated or inflatable raft 1600 embodying one or more aspects of the present disclosure. As shown, the raft 1600 includes a bottom 1604 and inflatable side segments 1608. The bottom 1604 and/or side segments 1608 can be translucent or transparent. The bottom 1604 and/or side segments 1608 can also be or include portions that are black-light sensitive.

With continued reference to the embodiment shown in FIG. 18, black light LEDs 1612 (or other suitable black light sources) are connected to one or more batteries 1616 (or other suitable power source). When the raft 1600 is in use, for example, in a body of water, the side segments 1608 are illuminated by the LEDs 1612. Alternative embodiments include light sources that do not emit black lights in addition to or as an alternative to the black light source 1612. In such embodiments, the raft can be configured such that the raft does not include any black-light-sensitive portions.

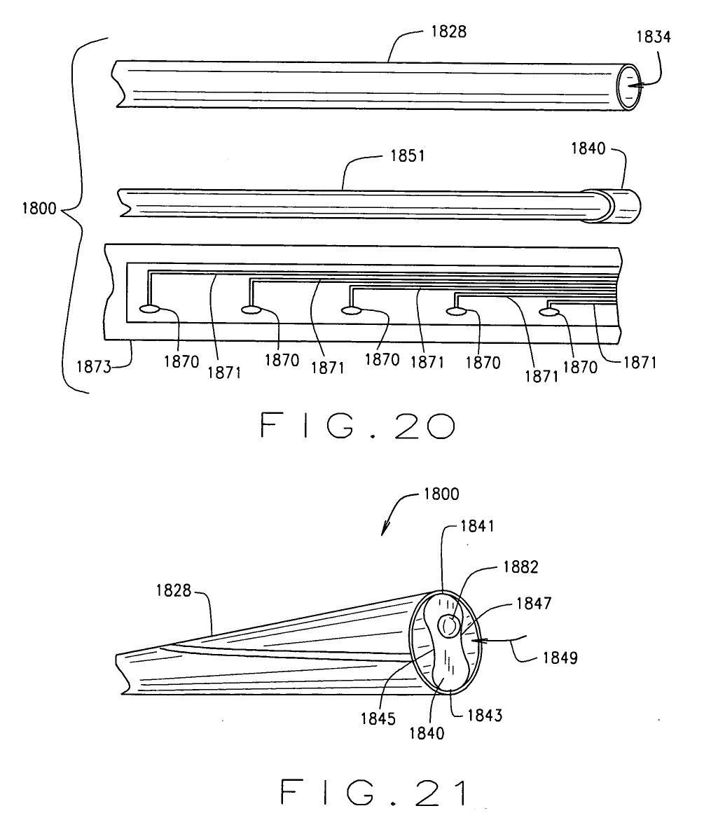

FIGS. 20 and 21 illustrate an exemplary embodiment of a lighting device or implement 1800 that can be used in connection with an inflated or inflatable object, such as a balloon, a ball, a lamp, a furniture item, a support for a body, a support for a body part, a raft, etc. As shown in FIG. 20, the lighting device 1800 includes an outer tube 1828 having an inner passage 1834 therethrough. In one particular embodiment, the outer tube 1828 is configured such that the inner passage 1834 has a diameter of about one-half inch. The dimensions set forth in this paragraph (as are all dimensions set forth herein) are mere examples and can be varied depending, for example, on the particular application.

The lighting device 1800 also includes a housing or cartridge 1840. As shown in FIG. 21, the housing 1840 can be positioned within the inner passage 1834. The housing's end portions 1841 and 1843 can be bonded or attached to the tube 1828 in an exemplary manner that allows fluid (e.g., air, helium, etc.) to flow within the inner passage 1834 of the tube 1828 generally around and past the housing's side portions 1845 and 1847 (as generally represented by arrows 1849 in FIG. 21).

The lighting device 1800 can also include one or more power sources and a switching mechanism 1882. The switching mechanism 1882 can be used for switchably connecting one or more light sources 1870 (FIG. 20) to one or more power sources within the housing 1840. A wide range of switching mechanisms can be used for switch 1882, such as push button switch, a dome push switch, a membrane switch, etc.

With continued reference to FIG. 20, the lighting device 1800 also includes an inner tube 1851 and at least one light source 1870 positionable within the inner tube 1851. In the particular embodiment illustrated in FIG. 20, LEDs 1870 and conductive leads 1871 are surface mounted on (e.g., electronically welded onto, etc.) a flexible lightweight ribbon cable 1873, which, in turn, is positionable within the inner tube 1851.

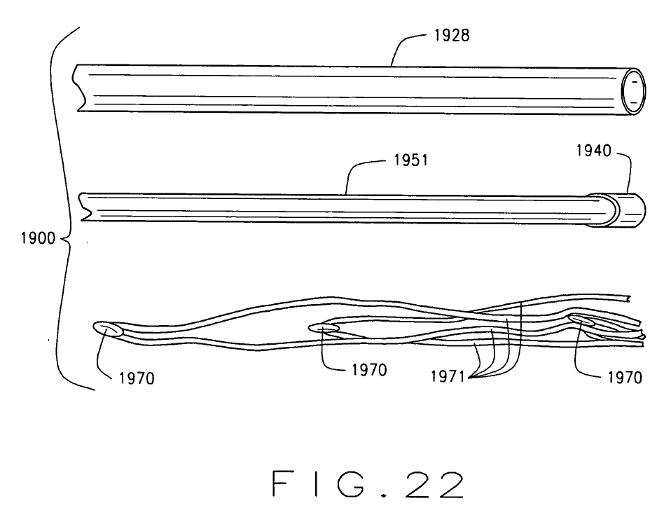

Alternatively, other light sources and conductive leads in any suitable number and/or other mounting methods are also possible. For example, FIG. 22 illustrates an alternative embodiment of a lighting device 1900 having an outer tube 1928, a housing 1940, an inner tube 1951, and LEDs 1970. But in this particular embodiment, the lighting device 1900 includes wiring 1971 for connecting the LEDs 1970 to one or more power sources within the housing 1940.

With reference back to FIGS. 20 and 21, the ribbon cable 1873 (along with the LEDs 1870 and conductive leads 1871 thereon) can be positioned within an inner cavity or passage of the inner tube 1851. By way of example, the flexible ribbon cable 1873 can be positioned within the inner tube 1851 such that the LEDs 1870 are spaced apart from one another generally along a length of the inner tube 1851. In addition, the LEDs 1870 can be electrically connected to one or more power sources (e.g., batteries, etc.) with the housing 1840 via conductive leads 1871.

After positioning the ribbon cable 1873 (along with the LEDs 1870 and conductive leads 1871 thereon) within the inner tube 1851, the inner tube 1851 can be sealed. In some embodiments, the inner tube 1851 may be hermetically sealed and/or sealed in a substantially fluid-tight fashion.

An exemplary process for assembling the lighting device 1800 will now be provided for illustrative purposes only. In one particular embodiment, the ribbon cable 1873 may be inserted through an open end of the inner tube 1851. At least a portion of the housing 1840 (and one or more components housed therein in some embodiments) may also be received within an open end of the inner tube 1851. The inner tube 1851 may be bonded or attached (e.g., adhesively bonded, chemically bonded, mechanically fastened, heat-sealed, hot-melted, etc.) to the housing 1840, thereby sealing the open end of the inner tube 1851. In some embodiments, both ends of the inner tube 1851 may be open with each end then being sealed by any suitable means (e.g., adhesively bonded, chemically bonded, mechanically fastened, heat-sealed, hot-melted, etc.). In some embodiments, the housing 1840 (along with the one or more power sources therein) can also be at least partially positioned within the inner tube 1851.

The sealed unit (comprising the inner tube 1851 bonded to the housing 1840 (or portion thereof) and components therein LEDs 1870, conductive leads 1871, and ribbon cable 1873) can then be inserted into the inner fluid flow passage 1834 of the outer tube 1828. End portions 1841 and 1843 of the housing 1840 can be bonded or attached (e.g., adhesively bonded, glued, adhered, friction fitted, etc.) to the tube 1828. Accordingly, fluid (e.g., air, gas, etc.) can be received within the inner fluid flow channel 1834 of the outer tube 1828 and flow generally past the housing side portions 1845 and 1847. Fluid may flow generally along the length of the outer surface of the sealed inner tube 1851 and components therein. That is, fluid may flow generally within the spaced distance separating the outer surface of the inner tube 1851 and the inner surface of the outer tube 1828.

The assembled lighting device 1800 may be used in connection with a wide range of inflated or inflatable objects for providing illumination effects. By way of example only, the lighting device 1800 can be used for illuminating at least a portion of a balloon, a ball, a lamp, a furniture item, a support for a body, a support for a body part, a raft, etc. In some embodiments, the outer tube 1828, inner tube 1851, and ribbon cable 1873 can have sufficient flexibility to allow the lighting device 1800 to be curved or bent, for example, to conform to one or more contours or curved surfaces of an inflated or inflatable object. The illustrated embodiment shows the tubes with a generally circular cross-section. Other embodiments, however, can include one or more tubes having a non-circular cross-sectional, such as rectangular, triangular, hexagonal, ovular, other polygonal shapes, etc.

In one example embodiment, the lighting device 1800 (or at least a portion thereof may be used in combination with a balloon having an inflation neck through which the balloon can be inflatable. In this example, at least one end portion of the lighting device 1800 can be inserted into and through the inflation opening of the balloon to thereby position at least one of the LEDs 1870 within the balloon. By way of example, the lighting device 1800 can be positioned such that the lighting device 1800 is substantially entirely enclosed within the balloon. As another example, the lighting device 1800 can be positioned only partially within the balloon, such that one or more LEDs 1870 (and, all LEDs 1870 in some embodiments, etc.) are within the balloon while at least a portion of the outer tube 1828 extends from within the balloon out through the balloon's inflation neck such that the switch 1882 is external to the balloon. In some embodiments, the outer tube 1828 can be configured (e.g., sized, positioned, etc.) such that at least a portion of the outer tube 1828 is external to the balloon and is sufficiently long for forming a suitable handle for user. A further example can include the lighting device 1800 being positioned relative to the balloon such that the switch 1882 is within the balloon's inflation neck, whereby the user can thus switchably connect the LEDs 1870 to the one or more power source(s) (e.g., batteries, etc.) within the housing 1840 by squeezing the inflation neck to activate/deactivate the switch 1882. The switch 1882 may also allow the user to cycle through the various display modes or select a particular color for the LEDs 1870 by successively squeezing the balloon's inflation neck. Additionally, the switch 1882 may also allow the user to dim or brighten the intensity of the light, for example, by holding down the switch 1882 with continuously applied pressure to the balloon's inflation neck.

The outer tube 1828 can also be used for supplying the inflated or inflatable object with fluid (e.g., airflow, helium, etc.). For example, a user may blow air into an open end of the outer tube 1828. The air may travel within the inner fluid flow channel 1834 of the outer tube 1828 and flow generally past the housing side portions 1845 and 1847. The air may flow generally along the length of the outer surface of the sealed inner tube 1851 and components therein. The air may flow generally within the spaced distance separating the outer surface of the inner tube 1851 and the inner surface of the outer tube 1828. Ultimately, the air is discharged from the other end of the outer tube 1828 into the inflated or inflatable object. In some embodiments, there is provided one or more closure devices (e.g., clip, sleeves, elastic bands, etc.) for sealing the inflation opening into the inflated or inflatable object. By way of example, various embodiments may include a clip for substantially sealing the inflation neck of a balloon against the outer surface of the outer tube 1828, and a plug or sealing member for substantially sealing the open end of the outer tube 1828 extending out through the neck. Alternatively, other means can also be employed for sealing the inflated or inflatable object.

Rather than sealing the inflation opening, other embodiments can include a device for providing a sufficient airflow through the inflation opening for inflating the object and also to inhibit deflation of the inflated object. For example, a fan that operates generally continuously can be provided that causes a sufficient airflow into the open end portion of the outer tube 1828 for inflating and/or inhibiting deflation of an object. Alternatively, other suitable devices can be used for providing or causing a sufficient airflow for inflating an object and/or inhibiting deflation of an inflated object.

A wide range of materials can be used for the tube 1828 and/or tube 1851. Exemplary materials include polyvinyl chloride (PVC), polymers, plastics, flexible materials, rigid materials, materials capable of being mass produced with relatively low manufacturing costs, among other materials suited for the intended purpose.

In any one or more of the various embodiments described and/or shown herein, a device may be provided for providing a sufficient airflow to inflate an object and also to inhibit deflation of the inflated object. For example, a fan that operates generally continuously can be provided that causes a sufficient airflow into the inflation opening of an inflatable object for inflating and then inhibiting deflation of the object. Alternatively, other suitable devices can be used for providing or causing a sufficient airflow for inflating an object and/or inhibiting deflation of an inflated object. In such embodiments, the inflation opening of the object would not need to be sealed, for example, with a clip or other closure device. Instead, the fan or other suitable device would provide the airflow for keeping the object inflated.

Other aspects of the present disclosure relate to kits, which can be useful for assembling a lighted inflated or inflatable object, such as any one or more of the apparatus or devices described herein and/or shown in FIGS. 1 through 19. In one particular embodiment, a kit for making a balloon apparatus includes an inflatable skin having at least a portion that is black-light sensitive and a black light source positioned or positionable so as to illuminate at least a portion of the inflated skin. Another embodiment of a kit for assembling an inflated object includes an inflatable skin, a display member positioned or positionable inside the skin and having at least a portion that is black-light sensitive, and a black light source positioned or positionable so as to illuminate at least a portion of the display member.

Aspects of the present disclosure also include methods of assembling an object, such as a balloon, a ball, a lamp, a furniture item, a support for a body, a support for a body part, a raft, etc. In various embodiments, the method generally includes inflating a skin having at least a portion that is black-light sensitive, and attaching a black light source to the object so as to illuminate the skin. Another embodiment of a method of assembling generally includes inflating a skin, attaching a display member to the skin, the display member having at least a portion that is black-light sensitive, and attaching a black light source to the object so as to illuminate the display member.

The lighted inflated or inflatable objects, methods, and kits described and/or shown herein are mere examples of the many combinations of aspects and features possible within the scope of the present disclosure. Further aspects and features of the present disclosure will become apparent from the detailed description and figures provided herein. In addition, any one or more aspects of the present disclosure may be implemented individually or in any combination with any one or more of the other aspects of the present disclosure. For example, any one of the balloon apparatus shown in FIGS. 1 through 11 and 19 can include one or more black lights and/or a balloon having at least a portion that is black-light sensitive. Or, for example, a different object (e.g., ball, furniture piece, chair, sofa, lamp, raft, pillow, body support and/or supports for body parts, etc.) can take the place of the balloon and be used with any one of the other devices shown in FIGS. 12 through 18. Balloons, balls, lamps, furniture, rafts, body supports and/or supports for body parts illuminated according to above described principles can be attractive, inexpensive to fabricate, and/or offer a variety of opportunities for play, decoration, and/or usefulness.

Some embodiments can include a housing or cartridge in which is housed one or more batteries (or other power sources). In such embodiments, the cartridge can be removable from the lighted inflated or inflatable object, for example, to replace the batteries. Some embodiments can also include rechargeable batteries. Other embodiments can include other power sources including disposable batteries, solar cells, kinetic power sources, etc.

Various embodiments can also include at least one power source spaced apart or remote from the lighted inflated or inflatable object. In such embodiments, at least one remote power source (e.g., rechargeable battery pack, wall outlet, etc.) can provide the electrical power for operation of the lighted inflated or inflatable object. The light source(s), in turn, may be electrically connected to the at least one remote power source by electrical wiring or cords (e.g., an insulated flexible electric wire fitted with a plug, etc.).

Some embodiments can include two or more batteries positioned side-by-side in an edge-to-edge orientation (as compared to being stacked or positioned on top of each other). For example, one exemplary embodiment can include two watch batteries positioned side-by-side in an edge-to-edge orientation. With this orientation, the watch batteries can be housed within a more low profile or thinner housing than embodiments in which the batteries are stacked on top of each another. Advantageously, thinner/more low profile housings can be positioned within inflation openings having smaller diameters than those particular embodiments having larger housings for the batteries.

In any one or more of the various embodiments disclosed herein, the operation of the light sources may be controlled by a controller in accordance with user input to provide such features as blinking, strobing, and/or color changes. The controller can include an integrated circuit/printed circuit assembly (e.g., integrated circuits in a printed circuit assembly) and at least one switch. The switch may, for example, allow the user to select from among various display modes for the light sources, such as an off-light mode, an on-light mode, a mode in which each of the light sources simultaneously emit steady or non-flashing light, a mode in which the light sources emit light intermittently, a mode in which the various light sources illuminate or blink at different times in accordance with a predetermined sequence or order, a mode in which the light sources emit light that phases between or blends colors, a mode in which the light sources emit light randomly, a mode in which the light sources pulsate to sounds (e.g., music at a nightclub, etc.), and/or a mode combining one or more of the foregoing. Such sounds may be produced by the lighted inflated or inflatable object itself (e.g., via a speaker built-in to the lighted item) or a source external to the lighted inflated or inflatable object (e.g., ambient sounds, etc.). In some embodiments, sounds can cause synchronized pulsation of the light sources of two or more different lighted inflated or inflatable objects, thus providing a pleasing light pattern or effect. The switch can include any one of a wide range of switches, a push-button switch, a dome push switch, a membrane switch, motion-responsive switches, light-sensitive switches, temperature-sensitive switches, compression switches, voice activated switches, moisture-sensitive switches, etc.

The various lighted inflated or inflatable objects disclosed herein can be configured to produce any of a wide range of colored light depending at least in part on user preferences. User preferences may in turn be based on any number of factors including the color of the clothes the user is wearing and/or the type of event (e.g., dance, sporting event, etc.) the user will attend with the lighted inflated or inflatable object. For example, the user may prefer a lighted inflated or inflatable object that produces colored light consistent with the home team's colors when attending a sporting event, such as a football game.

In any one or more of the various embodiments disclosed herein, a lighted inflated or inflatable object may include a vibrator for causing at least a portion of the lighted inflated or inflatable object to vibrate. In such embodiments, the vibrator may be configured for imparting sufficient vibration to the lighted inflated or inflatable object for also imparting at least some vibration to the lighted inflated or inflatable object is placed. By way of example only, the vibrator may comprise a relatively small motor off-access or a piezoelectric buzzer. Other examples of vibrators include an electromagnetic motor, rotor shaft, and eccentric rotor.

In some embodiments, a lighted inflated or inflatable object can include one or more electroluminescent light sources (e.g., one or more electroluminescent wires, electroluminescent sheeting, combinations thereof, etc.) that extend from at least one power source to form at least one display member for the lighted inflated or inflatable object. The display member can be enclosed, for example, in a clear casing formed by turning over and sealing a seam of the lighted inflated or inflatable object at which portions of the lighted inflated or inflatable object are joined together. When the power source is activated, the electroluminescent light source provides light. Alternatively, other embodiments can include additional or alternative light sources (e.g., LEDs, chemiluminescent light sources, black light sources, etc.) disposed within a casing at least partially formed by a seam. Further embodiments can also include a casing at least partially formed by a seam internal to or within the lighted inflated or inflatable object. By way of example, various embodiments include an internal or external pocket or pouch at least partially formed by a corresponding internal or external seam, where at least one light source (e.g., glow stick, LED array, electroluminescent light source, LED, chemiluminescent light source, etc.) is disposed within the pouch or pocket. In some embodiments, a lighted inflated or inflatable object includes a display member in the form of a sticker that is transparent and/or translucent at least in part, such that an electroluminescent light source (e.g., electroluminescent wire, etc.) beneath the sticker can be visible. The sticker can be applied over the electroluminescent light source and onto the lighted inflated or inflatable object.

In other embodiments, one or more electroluminescent light sources (e.g., electroluminescent wire, electroluminescent sheeting material, combinations thereof, etc.) include sticky or adhesive backing such that the electroluminescent light source(s) can be applied directly onto the lighted inflated or inflatable object. The electroluminescent light source(s) can be connected to at least one power supply, such as a button battery and/or other power supply.

In some embodiments, a lighted inflated or inflatable object includes one or more electroluminescent light sources (e.g., one or more electroluminescent wires, electroluminescent sheeting materials, combination thereof, etc.) positioned generally between an inner layer and an outer layer of the lighted inflated or inflatable object. Additional embodiments include one or more electroluminescent sheeting materials disposed within and applied to one or more inner surface portions of a lighted inflated or inflatable object. Further embodiments include one or more electroluminescent sheeting materials applied to one or more outer surface portions of a lighted inflated or inflatable object.

Other aspects provide methods relating to the use of lighted inflated or inflatable objects. In one exemplary embodiment, a method generally includes transmitting a signal to at least one lighted inflated or inflatable object from a source external to the lighted inflated or inflatable object, receiving the signal (e.g., wirelessly, etc.) at the lighted inflated or inflatable object, and controlling the operation of at least one light source of the lighted inflated or inflatable object in accordance with the signal. In some embodiments, a method can also include transmitting the signal to a plurality of lighted inflated or inflatable objects each of which includes at least one light source; and controlling operation of the light sources in accordance with the signal (e.g., synchronizing the operation of the light sources in accordance with the signal, etc.).

The operation of the light sources of the lighted inflated or inflatable objects can be synchronized in accordance with the signal to provide a stimulating and pleasing visual light display or effect. For example, fans at a sporting event can use lighted inflated or inflatable objects that include light sources which, in response to a signal, emit synchronized flashing light in colors consistent with the home team's colors. Or for example, the signal may cause the light sources to produce a lighted wave-like effect through the stadium stands.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order or performance. It is also to be understood that additional or alternative steps may be employed.

The description of the disclosure is merely exemplary in nature and, thus, variations that do not depart from the gist of the disclosure are intended to be within the scope of the disclosure. Such variations are not to be regarded as a departure from the spirit and scope of the disclosure.

What is claimed is:

1. An apparatus comprising an inflated or inflatable object having at least one portion responsive to black light, and at least one source disposed within the inflated or inflatable object, the at least one light source including at least one black light source for directing black light generally towards the at least one black light-responsive portion.

2. The apparatus of claim 1, wherein the at least one black light source comprises at least one black light LED.

3. The apparatus of claim 1, wherein the inflated or inflatable object includes one or more indicia responsive to black light.

4. The apparatus of claim 1, wherein the inflated or inflatable object comprises at least one of a balloon, a ball, a lamp, a furniture piece, a raft, a pillow, a slide, a swimming pool, a bouncing platform, or a support for a body part.

5. The apparatus of claim 1, further comprising wiring connecting at least one power source to the at least one light source, and at least one tube through which the wiring extends and substantially entirely enclosed within the inflated or inflatable object.

6. The apparatus of claim 5, wherein the at least one tube is entirely enclosed within the inflated or inflatable object.

7. The apparatus of claim 1, further comprising at least one device in communication with an inflation opening of the inflated or inflatable object for providing a sufficient airflow through the inflation opening into the inflated or inflatable object for inhibiting deflation of the inflated or inflatable object.

8. The apparatus of claim 1, further comprising at least one light-altering member within the inflated or inflatable object for receiving and altering light from the at least one light source by at least one or more of refracting, reflecting, diffracting, dispersing, and diffusing such that the altered light illuminates at least a portion of the inflated or inflatable object.

9. The apparatus of claim 1, further comprising at least one member configured for show inside the inflated or inflatable object, the at least one member including at least one or more of a projection member configured to direct light from the at least one source, a diffusion member configured to diffuse light from the at least one light source, a flag configured to rotate about the at least one light source, an optical fiber, and a display member.

10. The apparatus of claim 1, wherein the inflatable or inflated object comprises an inflatable or inflated furniture piece, and wherein the at least one black light LED is suspended within the inflatable or inflatable furniture piece by at least one thread having at least a portion responsive to black light.

11. A lighting device for an inflated or inflatable object having at least one inflation opening through which the inflated or inflatable object can receive fluid therein, the lighting device comprising at least one light source, at least one tube through which wiring extends for connecting the at least one light source to at least one power source, and at least one light-altering member at least partially supported by the tube and insertable through the at least one inflation opening for positioning within the inflated or inflatable object for receiving and altering light from the at least one light source by at least one or more of refracting, reflecting, diffracting, dispersing, and diffusing such that the altered light illuminates at least a portion of the inflated or inflatable object.

12. The lighting device of claim 11, wherein the at least one light source, at least one end portion of the at least one tube, and the at least one light-altering member are configured for insertion within an inflation neck of a balloon.

13. The lighting device of claim 11, further comprising at least one switching device configured for positioning within an inflation neck of a balloon such that the squeezing the inflation neck activates the switching device, and, thereby, to switchably connect the at least one light source to the at least one power source via the wiring within the at least one tube.

14. The lighting device of claim 13, wherein the lighting device is positionable entirely within the inflated or inflatable object.

15. The lighting device of claim 11, wherein the tube comprises a first end portion supporting the at least one light source and the at least one light-altering member, and wherein the first end portion, the at least one light source, and the at least one light-altering member are configured for insertion through the inflation opening of the inflated or inflatable object.

16. The lighting device of claim 11, wherein the light-altering member includes at least one or more of a projection member configured to direct light from the at least one source, a diffusion member configured to diffuse light from the at least one light source, a flag configured to rotate about the at least one light source, an optical fiber, and a display member.

17. An apparatus comprising an inflated or inflatable object having a closable inflation neck through which the inflatable object can be inflated, at least one light source within the inflated or inflatable object, wiring connecting at least one power source to the at least one light source, and at least one switching device configured such that the squeezing the inflation neck activates the switching device, and, thereby, to switchably connect the at least one light source to the at least one power source.

18. The apparatus of claim 17, wherein the wiring, the at least one light source, and the at least one switching device are entirely enclosed within the inflatable object.

19. The apparatus of claim 17, wherein at least a portion of at least one or more of the wiring, the at least one light source, and the at least one switching device are at least partially external to the inflatable object.

20. The apparatus of claim 17, wherein the inflated or inflatable object comprises a balloon.

21. An apparatus comprising an inflated or inflatable object having an inflation opening, at least one seam extending at least partially along at least a portion of the inflated or inflatable, at least one casing formed at the at least one seam, and at least one light source within the casing.

22. The apparatus of claim 21, wherein the at least one seam and the at least one casing are external to the inflated or inflatable object.

23. The apparatus of claim 21, wherein the at least one seam and the at least one casing are internal to the inflated or inflatable object.

24. The apparatus of claim 21, wherein the inflated or inflatable object comprises a balloon.

25. The apparatus of claim 21, wherein the at least one seam and at least one casing form at least one pocket for removably receiving at least one light source therein.

26. The apparatus of claim 21, wherein the at least one light source comprises at least one electroluminescent light source within the casing.

27. The apparatus of claim 21, wherein the at least one light source comprises at least one LED within the casing.

28. An apparatus comprising an inflated or inflatable object having at least one inflation opening, at least one light source within the inflated or inflatable object, at least one tube through which wiring extends for connecting the at least one light source to at least one power source, the at least one tube substantially entirely enclosed within the inflated or inflatable object, and at least one light-altering member configured for receiving and altering light from the at least one light source by at least one or more of refracting, reflecting, diffracting, dispersing, and diffusing such that the altered light illuminates at least a portion of the inflated or inflatable object.

29. The apparatus of claim 28, wherein the inflated or inflatable object comprises a balloon.

30. The apparatus of claim 29, further comprising at least one switching device configured such that squeezing an inflation neck of the balloon activates the switching device, and, thereby, to switchably connect the at least one light source to the at least one power source via the wiring within the at least one tube.

31. The apparatus of claim 28, wherein the light-altering member includes at least one or more of a projection member configured to direct light from the at least one source, a diffusion member configured to diffuse light from the at least one light source, a flag configured to rotate about the at least one light source, an optical fiber, and a display member.

32. The apparatus of claim 28, further comprising at least one clip for sealing the at least one inflation opening, and at least one sleeve that fits over the at least one tube and is configured to support the at least one clip to inhibit deflation of the inflated or inflatable object when the at least one clip is applied to the at least one inflation opening, the at least one sleeve configured to permit movement of the at least one tube by a user to move the at least one light source within the inflated or inflatable object.

33. The apparatus of claim 28, wherein the at least one tube is entirely enclosed within the inflated or inflatable object.

34. The apparatus of claim 28, wherein the at least one tube comprises a heat-shrinkable material.

35. The apparatus of claim 28, further comprising at least one device in communication with the at least one inflation opening of the inflated or inflatable object for providing a sufficient airflow through the inflation opening into the inflated or inflatable object for inhibiting deflation thereof.

36. The apparatus of claim 28, further comprising at least one light-altering member within the inflated or inflatable object for receiving and altering light from the at least one light source by at least one or more of refracting, reflecting, diffracting, dispersing, and diffusing such that the altered light illuminates at least a portion of the inflated or inflatable object.

37. The apparatus of claim 28, further comprising at least one member configured for show within the inflated or inflatable object, the at least one member including at least one or more of a projection member configured to direct light from the at least one source, a diffusion member configured to diffuse light from the at least one light source, a flag configured to rotate about the at least one light source, an optical fiber, and a display member.

38. A lighting device for an inflatable or inflated object having at least one inflation opening through which the inflated or inflatable object can receive fluid therein, the lighting device comprising:
a first tube having at least one inner fluid flow passage therethrough in which fluid may be received and delivered through the at least one inner fluid flow passage into the inflatable or inflated object;
a second tube having at least one inner cavity therein, at least a portion of the second tube being situated in the at least one inner fluid flow passage such that fluid may be received in and drawn through the at least one inner fluid flow passage generally around and past the at least a portion of the second tube in the at least one inner fluid flow passage;
at least one light source at least partially positioned within the at least one inner cavity of the second tube;
at least one housing configured to receive at least one power source therein for electrically powering the at least one light source, at least a portion of the at least one housing being situated in the at least one inner fluid flow passage such that fluid may be received in and drawn through the at least one inner fluid flow passage generally around and past the at least a portion of the at least one housing in the at least one inner fluid flow passage; and
at least one electrically-conductive lead extending from the at least one light source through at least a portion of the at least one inner cavity of the second tube to the at least one housing for electrically connecting the at least one light source to the at least one power source within the at least one housing.

39. An inflated or inflatable object comprising the lighting device of claim 38.

40. The lighting device of claim 38, wherein the at least one housing includes generally opposing end portions and generally opposing side portions, and wherein at least one of the housing's end portions are attached to the first tube with the housing's side portions a spaced distance away from the first tube such that fluid may be received in and drawn through the spaced distance separating the housing's side portions from the first tube.

41. The lighting device of claim 38, further comprising at least one substrate situated within the at least one inner cavity of the second tube, and wherein the at least one light source and the at least one electrically-conductive lead are coupled to the at least one substrate.

42. The lighting device of claim 38, further comprising at least one ribbon cable situated within the at least one inner cavity of the second tube, wherein the at least one light source comprises at least one LED coupled to the at least one ribbon cable, and wherein the electrically-conductive lead is coupled to the at least one ribbon cable.

43. The lighting device of claim 38, wherein the outer tube, inner tube, and at least one conductive lead have sufficient flexibility for allowing the lighting device to conform with a contoured portion of the inflated or inflatable object.

44. The lighting device of claim 38, wherein the lighting device is configured for insertion within an inflation neck of a balloon.

45. A balloon comprising an inflation neck and the lighting device of claim 38 at least partially within the inflation neck such that the at least one light source is within the balloon, and the at least one switching device is within the inflation neck such that the squeezing the inflation neck activates the switching device, and, thereby, switchably connects the at least one light source to the at least one power source.

46. A balloon comprising the lighting device of claim 38 positioned entirely within the balloon.
